(19) United States
(12) Patent Application Publication
(10) Pub. No.: US 2018/0092113 A1
(43) Pub. Date: Mar. 29, 2018

(54) COMMUNICATION METHOD, COMMUNICATION DEVICE, AND COMMUNICATION SYSTEM

(71) Applicant: FUJITSU LIMITED, Kawasaki-shi (JP)

(72) Inventors: Katsuhiko NEGOTO, Yokohama (JP); Tetsuta Sakabe, Yokohama (JP); Nobuyuki Fukuda, Yokohama (JP)

(73) Assignee: FUJITSU LIMITED, Kawasaki-shi (JP)

(21) Appl. No.: 15/682,173

(22) Filed: Aug. 21, 2017

(30) Foreign Application Priority Data
Sep. 27, 2016 (JP) 2016-188832

(51) Int. Cl. H04W 72/12; H04W 28/06; H04L 12/865; H04L 12/851

(52) U.S. Cl. CPC H04W 72/1247; H04W 28/065; H04L 47/365; H04L 47/24; H04L 47/6275

(57) ABSTRACT

A communication method executed by a processor included in a communication device, the communication method includes starting transmitting a first frame; when an opportunity to transmit a second frame having a higher priority than the first frame occurs during transmission of the first frame, generating a third frame including a part of data of the first frame; transmitting the generated third frame; transmitting the second frame after transmitting the generated third frame; generating a fourth frame including a header of the first frame and untransmitted data of the first frame after transmitting the second frame; and transmitting the generated fourth frame.

### CROSS-REFERENCE TO RELATED APPLICATION

This application is based upon and claims the benefit of priority of the prior Japanese Patent Application No. 2016-188832, filed on Sep. 27, 2016, the entire contents of which are incorporated herein by reference.

### FIELD

The embodiments discussed herein are related to a communication method, a communication device, and a communication system.

### BACKGROUND

In a relay node such as a layer 2 (L2) switch or a router device on Ethernet (registered trademark), for example, contention may occur between data of low priority and data of high priority. Also in a node at a termination point, contention in data transmission or the like may occur between service handling data of low priority and service handling data of high priority. For example, delay fluctuation may occur such that information of high priority which information is to arrive periodically in service or data relay desired to have low-delay and real-time characteristics does not arrive periodically due to the presence of information of low priority which information has a long data length.

A similar problem may also occur in a radio network system such as long term evolution (LTE). Message transmission with small delay fluctuations is desired in voice over long term evolution (VoLTE), videophone service, time division duplex-long term evolution (TDD-LTE), or precision time protocol (PTP). In a next-generation radio network system such as LTE-Advanced Pro or fifth generation (5G), a delay within one millisecond is desired with an eye toward the provision of vehicle-to-X (V2X) or internet of things (IoT) service for industrial machinery and the like.

There is a technology of dividing (fragmenting) a low-priority frame and transmitting the divided frames as a technology of transmitting a high-priority frame with a low delay without being affected by a traffic load. For example, there are related technologies which may preferentially transmit a high-priority frame by fragmenting a low-priority frame in advance and transmitting the fragmented frames (for example, Japanese Laid-open Patent Publication No. 2001-257686 and Japanese Laid-open Patent Publication No. 2011-172135). Also there are related technologies in which, when transmission of a frame having a higher priority than a frame being transmitted becomes possible, the data transmission of the low-priority frame is suspended to enable the transmission of the high-priority frame (for example, Japanese Laid-open Patent Publication No. 2015-126499, Japanese National Publication of International Patent Application No. 2013-534103, and Japanese Laid-open Patent Publication No. 2016-005023). In Japanese Laid-open Patent Publication No. 2016-005023, for example, a format converting unit performs the following processing when an opportunity to transmit a subsequent packet having a higher priority than a preceding packet of low priority arrives during transmission of data included in the preceding packet. For example, the format converting unit converts the preceding packet into two fragment packets by dividing the preceding packet during the transmission of the data included in the preceding packet of low priority. An L1 processing unit transmits the subsequent packet of high priority between the two fragment packets after the conversion.

However, with the related technologies, it is difficult to realize a versatile method for suppressing the occurrence of a delay in transmission of data having a high priority. It is desirable to be able to provide a versatile method that more accurately suppresses the occurrence of a delay in transmission of data having a high priority.

### SUMMARY

According to an aspect of the embodiments, a communication method executed by a processor included in a communication device, the communication method includes starting transmitting a first frame; when an opportunity to transmit a second frame having a higher priority than the first frame occurs during transmission of the first frame, generating a third frame including a part of data of the first frame; transmitting the generated third frame; transmitting the second frame after transmitting the generated third frame; generating a fourth frame including a header of the first frame and untransmitted data of the first frame after transmitting the second frame; and transmitting the generated fourth frame.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of configuration of a system to which one embodiment of a communication device is applied;

FIG. 2 is a diagram illustrating an example of configuration of a transmitting side device in one embodiment of a communication device;

FIG. 3 is a diagram illustrating an example of configuration of a receiving side device in one embodiment of a communication device;

FIG. 4A, FIG. 4B, and FIG. 4C are diagrams illustrating an example of data formats of a virtual local area network (VLAN) tag field and a fragment field;

FIG. 5 is a diagram illustrating an example of a data format of a frame of low priority in the present embodiment;

FIG. 6 is a diagram of assistance in explaining an example of detailed operation of an L2 transmitting unit within an L2 processing unit in a transmitting side device in one embodiment of a communication device;

FIG. 7 is a diagram of assistance in explaining an example of detailed operation of a separating unit and an assembling unit within an L2 processing unit in a receiving side device in one embodiment of a communication device;

FIG. 8 is a diagram of assistance in explaining an example of operation of a related technology to be compared with the present embodiment;

FIG. 9A and FIG. 9B are diagrams of assistance in explaining an example of operation of a terminating device to which one embodiment of a communication device is applied;

FIG. 10 is a diagram of assistance in explaining an example of operation of a relay device to which one embodiment of a communication device is applied (in a case where the relay device is capable of both assembly and division);

FIG. 11 is a diagram of assistance in explaining an example of operation of a relay device to which one embodiment of a communication device is applied (in a case where the relay device is capable of only division);

FIG. 12 is a diagram of assistance in explaining an example of operation of a relay device to which one embodiment of a communication device is applied (in a case where the relay device is capable of only assembly);

FIG. 13 is a diagram of assistance in explaining an example of operation of a relay device to which one embodiment of a communication device is not applied;

FIG. 14A and FIG. 14B are flowcharts illustrating an example of processing of an L2 transmitting unit;

FIG. 15 is a flowchart illustrating an example of processing of a separating unit and an assembling unit;

FIG. 16 is a flowchart illustrating an example of processing of an L3 monitoring unit in a case where there are three or more priority classes;

FIG. 17 is a diagram of assistance in explaining an example of detailed operation of an L2 transmitting unit within an L2 processing unit in a transmitting side device in one embodiment of a communication device in a case of three priority classes;

FIG. 18A and FIG. 18B are diagrams illustrating an example of hardware configuration in which embodiments of a transmitting side device and a receiving side device may be implemented as a terminating device; and

FIG. 19A and FIG. 19B are diagrams illustrating an example of hardware configuration in which embodiments of a transmitting side device and a receiving side device may be implemented as a relay device.

### DESCRIPTION OF EMBODIMENTS

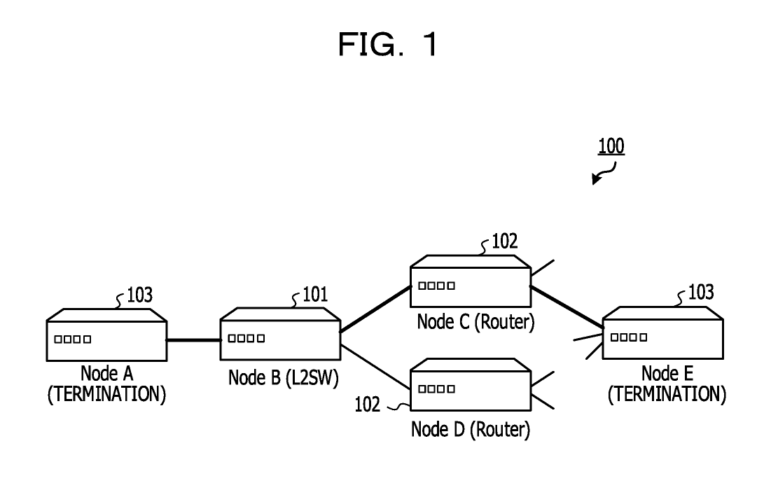

Embodiments will hereinafter be described in detail with reference to the drawings. FIG. 1 is a diagram illustrating an example of configuration of a system to which one embodiment of a communication device is applied. The one embodiment of the communication device is applicable to relay nodes such as a layer 2 switch (a “Node B (L2SW)” in FIG. 1) 101 and a router device (a “Node C (Router)” or a “Node D (Router)” in FIG. 1) 102 on an Ethernet 100. The one embodiment of the communication device is also applicable to a node (a “Node A (termination)” or a “Node E (termination)” in FIG. 1) 103 at a termination point.

In the one embodiment of the communication device, when an opportunity to transmit a second frame having a higher priority than a first frame occurs during transmission of the first frame of low priority from a transmitting side device, the transmitting side device performs the following operation. The transmitting side device suspends the transmission of data in the first frame, and converts the frame being transmitted into a third frame including a part of the first frame. The transmitting side device then transmits the second frame of high priority after transmitting the third frame. The transmitting side device thereafter transmits a fourth frame including the header of the first frame and data yet to be transmitted in the first frame. This versatile method may suppress the occurrence of a delay in the transmission of data of high priority.

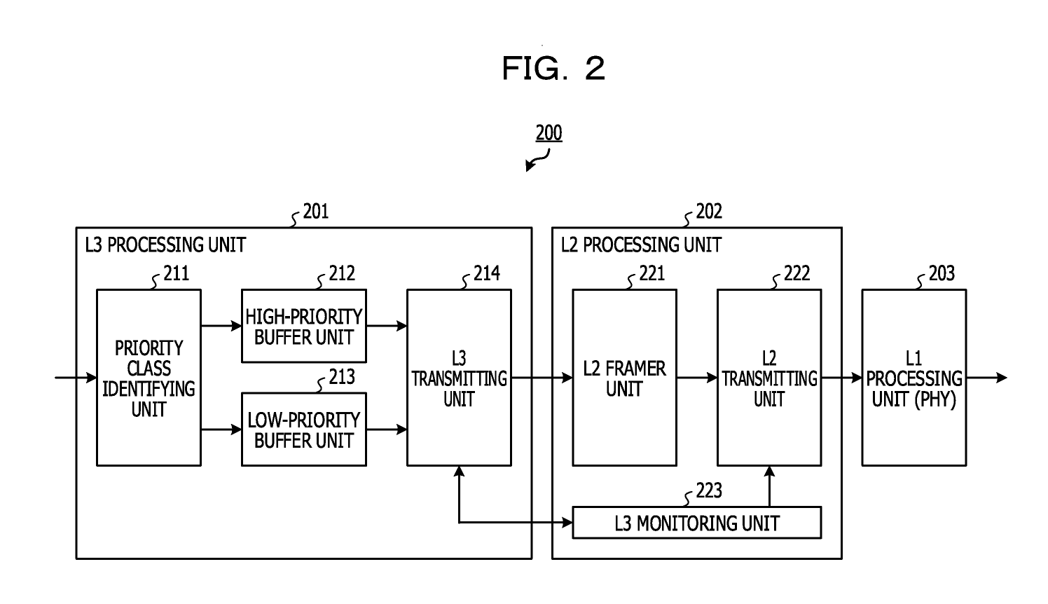

FIG. 2 is a diagram illustrating an example of configuration of a transmitting side device in one embodiment of a communication device. A transmitting side device 200 depicted in FIG. 2 is, for example, implemented for each output port of the communication device. An L3 processing unit 201 performs priority control on an internet protocol (IP) packet in an L3 layer which packet is transferred from a higher-level device. In a case where the communication device including the transmitting side device 200 is, for example, a relay node such as the Node B (L2SW) 101 or the Node C/D (Router) 102 in FIG. 1, the higher-level device is a device that performs routing in the L3 layer (IP level). The IP packet as a result of being routed is input from the higher-level device to the L3 processing unit 201. In a case where the communication device including the transmitting side device 200 is, for example, a node at a termination point such as the Node A/E (termination) 103 in FIG. 1, the higher-level device generates an IP packet storing transmission data output as a result of execution of an application program, and inputs the IP packet to the L3 processing unit 201. The IP packet is next formed into an Ethernet frame by an L2 processing unit 202. An L1 processing unit (physical layer (PHY)) 203 further converts the Ethernet frame into a signal having a signal format of a transmission line to which the transmitting side device 200 is coupled, and transmits the signal.

The L3 processing unit 201 includes a priority class identifying unit 211, a high-priority buffer unit 212, a low-priority buffer unit 213, and an L3 transmitting unit 214.

The priority class identifying unit 211 identifies the priority class of transmission data transferred from the higher-level device by distinguishing the service name of the transmission data or the like. For example, in a case where there are two kinds of priority classes and the priority class identifying unit 211 identifies the priority of the transmission data as high priority, the priority class identifying unit 211 makes the high-priority buffer unit 212 temporarily hold the transmission data. In a case where the priority class identifying unit 211 identifies the priority of the transmission data as low priority, on the other hand, the priority class identifying unit 211 makes the low-priority buffer unit 213 temporarily hold the transmission data. There may be three kinds of priority classes or more. In that case, respective priority buffer units corresponding to the kinds are implemented. Then, the priority class identifying unit 211 makes the priority buffer units corresponding to the identified priorities temporarily hold transmission data.

The L3 transmitting unit 214 reads out the transmission data of each priority from the high-priority buffer unit 212 or the low-priority buffer unit 213 at an output ratio in accordance with the types of the priority classes. The L3 transmitting unit 214 then outputs the transmission data to the L2 processing unit 202.

The L2 processing unit 202 includes an L2 framer unit 221, an L2 transmitting unit 222, and an L3 monitoring unit 223.

The L2 framer unit 221 is supplied with an IP packet sequentially transmitted from the L3 transmitting unit 214 within the L3 processing unit 201. The L2 framer unit 221 generates an Ethernet frame (hereinafter referred to simply as a “frame”) in an L2 layer in which frame an Ethernet header (hereinafter referred to as an “Ether header”) is added to a head, the IP packet is added to a payload, and a frame check sequence (FCS) is added to a tail end, and outputs the frame to the L2 transmitting unit 222. The Ether header includes respective fields of a destination media access control (MAC) address, a transmission source MAC address, and a type or a length.

The L3 monitoring unit 223 monitors which of transmission data of high priority and transmission data of low priority is input from the L3 transmitting unit 214 within the L3 processing unit 201 to the L2 framer unit 221. When the L3 monitoring unit 223 detects that transmission data of high priority is input to the L2 framer unit 221, the L3 monitoring unit 223 notifies a dividing instruction to the L2 transmitting unit 222.

The L2 transmitting unit 222 performs conversion and transmission processing on a frame input from the L2 framer unit 221. At a time of transmission of a first frame of low priority, the L2 transmitting unit 222 first inserts a VLAN tag field between a transmission source MAC address field and a type or length field in an Ether header set in the frame. The format of the VLAN tag field is compliant with the IEEE 802.1Q standard established by the IEEE 802.1 working group. The Institute of Electrical and Electronics Engineers, Inc. (IEEE) is a society for electric engineering and electronic engineering technologies, the society having headquarters in the United States of America. At this time, the L2 transmitting unit 222 stores a given tag protocol identifier in the VLAN tag field, the tag protocol identifier indicating that the first frame may be divided in the L2 layer and transmitted. Then, the L2 transmitting unit 222 adds a fragment field (hereinafter described as a “Fragment field”) to a tail end of a payload in the first frame. Information indicating that the first frame including the Fragment field is not a divided frame on a receiving side is stored in the Fragment field. Further, the L2 transmitting unit 222 recalculates an FCS from the Ether header including the newly inserted VLAN tag field and the payload, and adds the FCS to a tail end of the first frame. The L1 processing unit 203 converts the first frame thus modified in the L2 transmitting unit 222 into a signal having the signal format of the transmission line to which the transmitting side device 200 is coupled, and sends out the signal to the transmission line.

The L2 transmitting unit 222 performs the following operation when notified, from the L3 monitoring unit 223 while transmitting the first frame input from the L2 framer unit 221, of the dividing instruction based on the occurrence of an opportunity to transmit a second frame having a higher priority than the first frame. The L2 transmitting unit 222 suspends the transmission of data in the first frame when completing transmission of a given number of bytes. The L2 transmitting unit 222 then converts the frame being transmitted into a third frame including a part of the first frame (operates as a converting unit). In this third frame, the Ether header including the already transmitted VLAN tag field in the first frame is set as an Ether header of the third frame as it is. Then, data up to an intermediate point of the data of the payload in the first frame constitutes a payload of the third frame. The L2 transmitting unit 222 next adds a fragment field (hereinafter described as a “Fragment field”) to a tail end of the payload in the third frame. This Fragment field stores assembly information for assembling the original first frame before the division using the third frame including the Fragment field on the receiving side. Then, following the Fragment field in the third frame, the L2 transmitting unit 222 recalculates and adds an FCS for the Ether header, the payload, and the Fragment field of the third frame. The L2 transmitting unit 222 thus generates and transmits the third frame to which the following are added: the same Ether header as in the first frame, the data of a first half part from a head of the payload of the first frame, the Fragment field, and the FCS. The L1 processing unit 203 converts the third frame transmitted from the L2 transmitting unit 222 into a signal having the signal format of the transmission line to which the transmitting side device 200 is coupled, and sends out the signal to the transmission line.

Next, the L2 transmitting unit 222 transmits the second frame of high priority as it is after transmitting the divided third frame of low priority (operates as a transmitting unit). The L1 processing unit 203 converts the second frame transmitted from the L2 transmitting unit 222 into a signal having the signal format of the transmission line to which the transmitting side device 200 is coupled, and sends out the signal to the transmission line.

After transmitting the second frame, the L2 transmitting unit 222 generates a fourth frame including the same Ether header as in the divided first frame and remaining divided data yet to be transmitted in the payload of the first frame as an Ether header and a payload, respectively. The L2 transmitting unit 222 adds a Fragment field to a tail end of the payload of the fourth frame. The Fragment field stores assembly information for assembling the original first frame before the division using the fourth frame including this Fragment field on the receiving side. Following the Fragment field, the L2 transmitting unit 222 calculates an FCS for the Ether header, the payload, and the Fragment field of the fourth frame, and adds the FCS to the fourth frame. The L2 transmitting unit 222 thus generates and transmits the fourth frame to which the following are added: the same Ether header as in the first frame, the remaining data yet to be transmitted in the payload of the first frame, the Fragment field, and the FCS. The L1 processing unit 203 converts the fourth frame transmitted from the L2 transmitting unit 222 into a signal having the signal format of the transmission line to which the transmitting side device 200 is coupled, and sends out the signal to the transmission line.

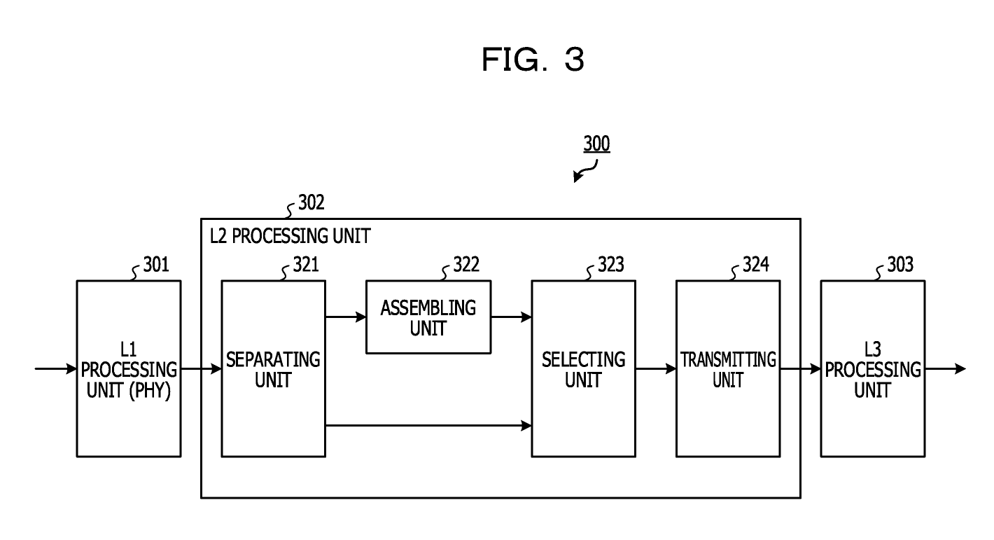

FIG. 3 is a diagram illustrating an example of configuration of a receiving side device in one embodiment of a communication device. In a receiving side device 300 depicted in FIG. 3, a received signal received from the transmission line and having the signal format of the transmission line is converted into a frame in the L2 layer (Ethernet frame) in an L1 processing unit (PHY) 301. This frame is decapsulated into an IP packet in an L2 processing unit 302. This IP packet is further input to an L3 processing unit 303. The L3 processing unit 303 transfers the IP packet input from the L2 processing unit 302 to a higher-level device. In a case where the communication device including the receiving side device 300 is a relay node such as the Node C/D (Router) 102 in FIG. 1, the higher-level device is a device that performs routing in the L3 layer (IP level). The IP packet to be routed is input from the L3 processing unit 303 to the higher-level device. In a case where the communication device including the receiving side device 300 is a node at a termination point such as the Node A/E (termination) 103 in FIG. 1, the higher-level device extracts received data from the IP packet received from the L3 processing unit 303, and inputs the received data to an application program being executed.

The L2 processing unit 302 includes a separating unit 321, an assembling unit 322, a selecting unit 323, and a transmitting unit 324.

The separating unit 321 determines whether or not the VLAN tag field storing the given tag protocol identifier described above in the description of the transmitting side device 200 in FIG. 2 is added to the Ether header of the frame input from the L1 processing unit 301. Further, the separating unit 321 determines whether or not the above-described Fragment field indicating that the frame is divided is added to a tail end of a payload in the frame. When results of the two determinations described above are YES, the separating unit 321 determines that the frame input from the L1 processing unit 301 is the above-described divided third or fourth frame of low priority, and outputs the frame to the assembling unit 322. When at least one of the results of the two determinations described above is NO, the separating unit 321 determine that the frame input from the L1 processing unit 301 is the undivided first frame of low priority or the second frame of high priority described above, and outputs the frame as it is to the selecting unit 323.

The selecting unit 323 selects a frame output from the assembling unit 322 or the frame output from the separating unit 321, and outputs the frame to the transmitting unit 324.

The transmitting unit 324 extracts an IP packet as a frame in the L3 layer from the frame in the L2 layer, and outputs the IP packet to the L3 processing unit 303.

The frame determined to be the undivided first frame of low priority or the second frame of high priority described above in the separating unit 321 is transferred as it is from the selecting unit 323 to the transmitting unit 324. Then, the IP packet extracted in the transmitting unit 324 from the frame input from the selecting unit 323 is sent to the L3 processing unit 303.

The frame input from the separating unit 321 to the assembling unit 322 is the third or fourth frame of low priority which frame is divided due to interruption transmission of the frame of high priority. The assembling unit 322 assembles the first frame before the division from each received third or fourth frame based on the assembly information stored in the Fragment field of the third or fourth frame input from the separating unit 321. The assembling unit 322 then transfers the reconstructed first frame to the transmitting unit 324 via the selecting unit 323. The transmitting unit 324 then sends the IP packet extracted from the first frame to the L3 processing unit 303.

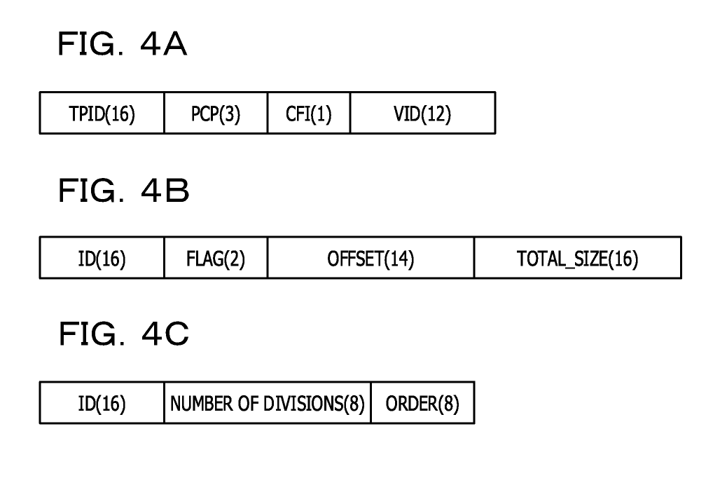

Operation of the transmitting side device 200 including the configuration of FIG. 2 and the receiving side device 300 including the configuration of FIG. 3 described above will be described below in detail. FIG. 4A, FIG. 4B, and FIG. 4C are diagrams illustrating an example of data formats of the VLAN tag field and the fragment field added to the above-described frames of low priority.

The data format of the VLAN tag field illustrated in FIG. 4A is compliant with the above-described IEEE 802.1Q protocol. In FIG. 4A, a number in parentheses in each field represents the number of bits of the field.

In FIG. 4A, a tag protocol identifier (TPID) field of 16 bits usually stores a numerical value such as 0x8100 or 0x9100 (“0x” denotes a hexadecimal number). On the other hand, in the present embodiment, the TPID field stores a special number TPID value (for example, 0x8101) as a given tag protocol identifier indicating that the present frame is transmitted after being divided in the L2 layer in the transmitting side device 200 of FIG. 2. This special number TPID value is a 16-bit value other than the above numerical value of 0x8100, 0x9100, or the like.

In FIG. 4A, a priority code point (PCP) field of 3 bits is a field specifying priority. The PCP field indicates the priority of the frame by values of 0 (lowest) to 7 (highest), and is used for prioritization of various kinds of traffic such as audio, moving images and data. In the present embodiment, the above-described priority is set in this PCP field in a case where divided frames of low priority are further hierarchized into a plurality of priorities.

In FIG. 4A, a canonical format identifier (CFI) of 1 bit is a field indicating, by a numerical value of 1 or 0, whether or not the above-described MAC address field is in a regular format. This CFI field is used at a time of interconnection between Ethernet and a token ring. However, the present embodiment is targeted for Ethernet, and therefore a value 1 is stored in the CFI field at all times.

In FIG. 4A, a VLAN identifier (VID) field of 12 bits specifies a VLAN to which the frame belongs. When the value of the VID field is zero, the value means that the frame does not belong to any VLAN, and the VLAN tag field with VID=0 is used as a mere priority tag field. A value 0xFFF of the VID field is reserved. Frames whose VID fields have values from 0x001 to 0xFFE are transmitted, received, or relayed as frames belonging to VLANs corresponding to the respective values.

Next, in the present embodiment, as described earlier in the description of the transmitting side device 200 of FIG. 2, a Fragment field having the data format of FIG. 4B or FIG. 4C is added at a tail end of a payload in each divided frame and in front of an FCS. This Fragment field stores assembly information for the assembling unit 322 within the L2 processing unit 302 in the receiving side device 300 of FIG. 3 to assemble an original frame (first frame) from the divided frame (third or fourth frame).

In the data format example of the Fragment field in FIG. 4B, respective fields of ID, FLAG, OFFSET, and TOTAL_SIZE are included as the above-described assembly information. The ID field of 16 bits is identifier information indicating that the third or fourth frame (divided frame) including the Fragment field is divided from the given first frame (original frame before the division) corresponding to the ID field. The FLAG field of 2 bits is flag information indicating whether or not another fourth frame divided from the first frame corresponding to the third or fourth frame follows the third or fourth frame including the field. A value 1 indicates that there is a following frame. A value 0 indicates that there is no following frame. The OFFSET field of 14 bits is offset information indicating an offset of divided data stored in the third or fourth frame including the field in the data of the first frame corresponding to the third or fourth frame. The TOTAL_SIZE field is information indicating the size of the data of the first frame corresponding to the third or fourth frame including the field.

In the data format example of the Fragment field in FIG. 4C, respective fields of ID, the number of divisions, and order are included as the above-described assembly information. The ID of 16 bits is the same as in FIG. 4B. The number of divisions field of 8 bits is information indicating the number of divisions minus one in the first frame corresponding to the third or fourth frame including the field. The order field of 8 bits is information indicating a division order of the divided data stored in the third or fourth frame including the field in the data of the first frame corresponding to the third or fourth frame.

The assembling unit 322 of FIG. 3 may assemble the first frame from the third or fourth frame whose ID field has the same value, by referring to the assembly information within the Fragment field having the data format of FIG. 4B or FIG. 4C.

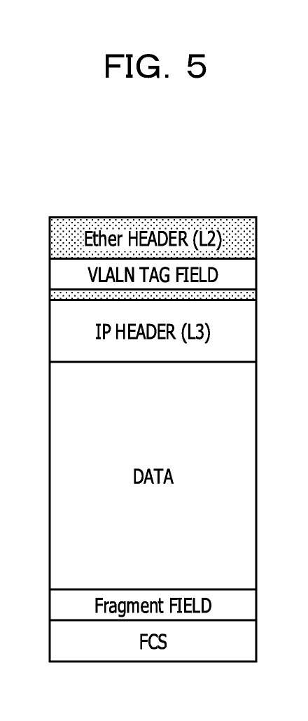

FIG. 5 is a diagram illustrating an example of a data format of the third or fourth frame of low priority in the L2 layer which frame is processed by the L2 processing unit 202 or 302 in FIG. 2 or FIG. 3 in the present embodiment. An Ether header is added to the head of the third or fourth frame, and a VLAN tag field storing a special number TPID is inserted between a transmission source MAC address field and a type or length field within the Ether header. A destination MAC address field, the transmission source MAC address field, and the type or length field within the Ether header are copied as they are from the Ether header of the first frame from which the third or fourth frame is generated. An IP packet in the L3 layer which IP packet is constituted of an IP header and data is stored in a payload following the Ether header. Further, a Fragment field having the data format of FIG. 4B or 4C is stored at a tail end of the payload. Then, an FCS calculated from the Ether header and the payload described above is added to an end of the third or fourth frame.

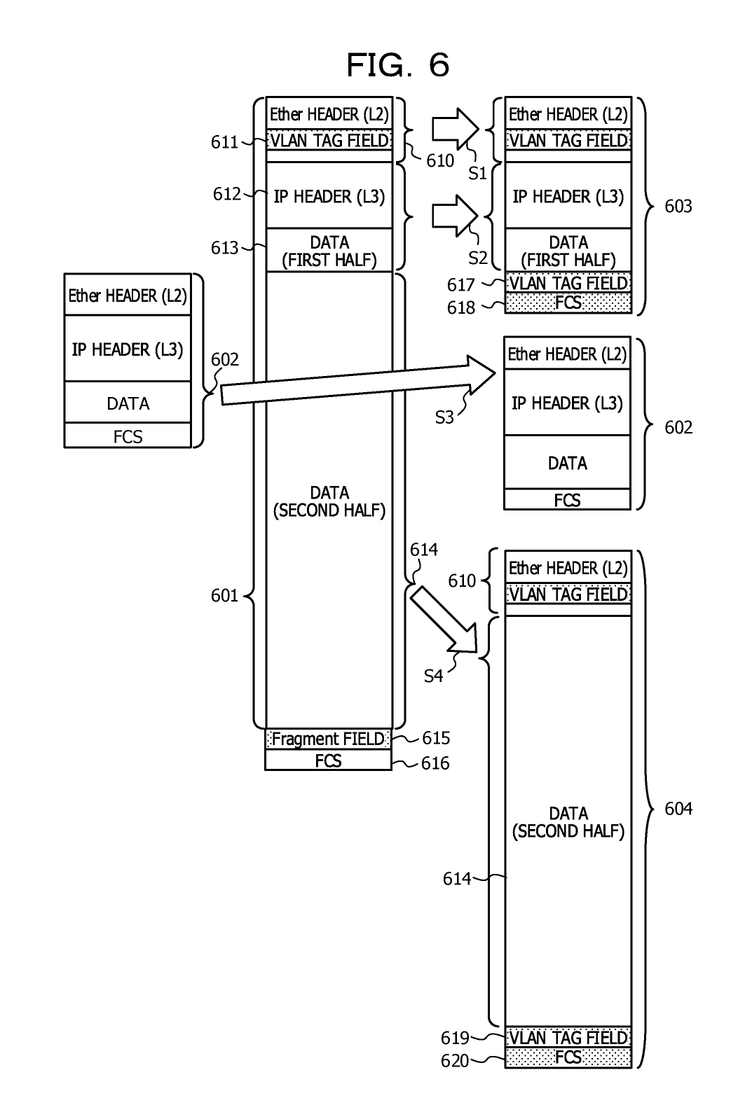

FIG. 6 is a diagram of assistance in explaining an example of detailed operation of the L2 transmitting unit 222 within the L2 processing unit 202 in the transmitting side device 200 of FIG. 2.

Now, suppose that the L2 transmitting unit 222 is performing processing of transmitting a first frame 601 of low priority. An Ether header 610 in the L2 layer is added to this first frame 601 by the L2 framer unit 221.

Irrespective of whether or not to divide the first frame, when the Ether header 610 has no VLAN tag field 611, the L2 transmitting unit 222 generates a VLAN tag field 611 in which a special number TPID is set, and stores the VLAN tag field 611 in the Ether header 610.

A payload of the first frame 601 stores an IP header 612 in the L3 layer and data including data (first half) 613 and data (second half) 614.

The L2 transmitting unit 222 generates a Fragment field 615, and adds the Fragment field 615 to a tail end of the payload. At this time, in the Fragment field 615, the L2 transmitting unit 222 sets the value of the FLAG field in FIG. 4B to a value 0 indicating that there is no following frame and sets the value of the OFFSET field in FIG. 4B to an offset value 0 indicating a head. Alternatively, the L2 transmitting unit 222 sets the value of the number of divisions field in FIG. 4C to zero in the Fragment field 615. The receiving side device 300 (FIG. 3) is thus notified that the first frame 601 is transmitted without being divided.

Further, the L2 transmitting unit 222 recalculates and corrects an FCS 616 at a tail end of the first frame 601 from the Ether header 610 including the VLAN tag field 611, the IP header 612, the data (first half) 613, the data (second half) 614, and the Fragment field 615.

The L2 transmitting unit 222 thus adds the VLAN tag field 611 and the Fragment field 615 to the first frame 601 input from the L2 framer unit 221. Then, the resulting first frame 601 is sent out from the L2 transmitting unit 222 to the transmission line via the L1 processing unit 203.

The L2 transmitting unit 222 performs the following operation when notified of a dividing instruction from the L3 monitoring unit 223 during the transmission of the first frame 601, the dividing instruction being based on the occurrence of an opportunity to transmit a second frame 602 of high priority.

The L2 transmitting unit 222 suspends the transmission of data in the first frame 601 when completing transmission of data to a tail end of the data (first half) 613, and converts the frame being transmitted into a third frame 603 including a part of the first frame 601. In the third frame 603, the already transmitted Ether header 610 including the VLAN tag field 611 in the first frame 601 is used as it is as an Ether header of the third frame 603 (S1 in FIG. 6). The IP header 612 and the data (first half) 613 in the payload of the first frame 601 are set as a payload of the third frame 603 (S2 in FIG. 6).

Next, the L2 transmitting unit 222 adds a Fragment field 617 to a tail end of the payload of the third frame 603. This Fragment field 617 stores assembly information for the receiving side device 300 (FIG. 3) to assemble the original first frame 601 before the division using the third frame 603 including the Fragment field 617. The assembly information is the information illustrated in FIG. 4B or FIG. 4C.

When the data format of FIG. 4B is adopted, a number for uniquely identifying the first frame 601 is generated and stored in the ID field. The FLAG field stores a value 1 indicating that a fourth frame 604 divided from the first frame 601 follows the third frame 603. The OFFSET field stores offset information of the data (first half) 613 in the payload of the first frame 601. The data (first half) 613 stored in the payload of the third frame 603 is stored from a head of the payload of the first frame 601. Thus, a value 0 is stored as the offset information. The TOTAL_SIZE field stores a total size of the data in the payload of the first frame 601, for example, the size of the data (first half) 613 plus the size of the data (second half) 614.

When the data format of FIG. 4C is adopted, on the other hand, a number for uniquely identifying the first frame 601 is generated and stored in the ID field. The number of divisions field stores a value 1 indicating that the first frame 601 is divided into two frames, for example, the third frame 603 and the fourth frame 604 in the case of FIG. 6. The order field stores a value 1 indicating that the third frame 603 is a first divided frame in the case of FIG. 6.

Then, following the above-described Fragment field 617 in the third frame 603, the L2 transmitting unit 222 recalculates and adds an FCS 618 for the Ether header 610, the IP header 612, the data (first half) 613, and the Fragment field 617 of the third frame 603.

Thus, even when an opportunity to transmit the second frame 602 of high priority occurs during the transmission of the first frame 601, the L2 transmitting unit 222 may continue the transmission by converting a part of the first frame 601 into the third frame 603 while the part of the first frame 601 remains in a transmitted state. The third frame 603 includes the Ether header 610 including the same VLAN tag field 611 as in the first frame 601, the data (first half) 613 from the head of the payload of the first frame 601, the Fragment field 617, and the FCS 618. Thus, the processing of division and conversion from the first frame 601 to the third frame 603 is achieved merely by performing the processing of extracting the data (first half) 613 of the payload of the first frame 601 and the processing of generating and adding the Fragment field 617 and the FCS 618. The occurrence of a transmission delay may therefore be suppressed in the processing of division from the first frame 601 to the third frame 603 and the processing of transmitting the third frame 603.

Next, after the transmission of the divided third frame 603 of low priority, the L2 transmitting unit 222 transmits the second frame 602 of high priority as it is, the second frame 602 being input from the L2 framer unit 221 (S3 in FIG. 6). The second frame 602 includes an Ether header 610, an IP header 612, data, and an FCS constituting an ordinary Ether frame. However, a VLAN tag field as in the first frame 601 and the third frame 603 is not added to the Ether header of the second frame 602.

After transmitting the second frame, the L2 transmitting unit 222 generates a fourth frame 604. This fourth frame 604 includes the same Ether header as the Ether header 610 storing the same VLAN tag field 611 as in the divided first frame 601. The fourth frame 604 includes, as a payload thereof, the divided remaining data (second half) 614 yet to be transmitted in the payload of the first frame 601.

The L2 transmitting unit 222 next adds a Fragment field 619 to a tail end of the payload of the fourth frame 604. This Fragment field 619 stores assembly information for the receiving side device 300 (FIG. 3) to assemble the original first frame 601 before the division using the fourth frame 604 including the Fragment field 619. The assembly information is the information illustrated in FIG. 4B or FIG. 4C.

When the data format of FIG. 4B is adopted, the ID field stores a number for uniquely identifying the first frame 601, the number being the same as the number given to the ID field in the Fragment field 617 of the third frame 603. The FLAG field stores a value 0 indicating that the fourth frame 604 is not followed by any frame divided from the first frame 601. The OFFSET field stores offset information of the data (second half) 614 in the payload of the first frame 601. The data (second half) 614 stored in the payload of the fourth frame 604 is stored next to the data (first half) 613 in the payload of the first frame 601. Thus, the data address of the tail end of the data (first half) 613 is stored as the value of the offset information. The TOTAL_SIZE field stores the total size of the data in the payload of the first frame 601, for example, the size of the data (first half) 613 plus the size of the data (second half) 614.

When the data format of FIG. 4C is adopted, on the other hand, the ID field stores a number for uniquely identifying the first frame 601, the number being the same as the number given to the ID field in the Fragment field 617 of the third frame 603. The number of divisions field stores a value 1 indicating that the first frame 601 is divided into two frames, for example, the third frame 603 and the fourth frame 604 in the case of FIG. 6. The order field stores a value 1 indicating that the fourth frame 604 is a second divided frame in the case of FIG. 6.

Then, following the Fragment field 619 in the fourth frame 604, the L2 transmitting unit 222 recalculates and adds an FCS 620 for the Ether header 610, the data (second half) 614, and the Fragment field 619 of the fourth frame 604.

Thus, the L2 transmitting unit 222 may transmit the fourth frame 604 of low priority, the fourth frame 604 being divided from the first frame 601, following the transmission of the second frame 602 of high priority. The processing of generating the fourth frame 604 from the first frame 601 is achieved by merely performing the processing of extracting the data (second half) 614 from the payload of the first frame 601, copying the Ether header 610, and generating and adding the Fragment field 619 and the FCS 620. The occurrence of a transmission delay may therefore be suppressed in the processing of division from the first frame 601 to the fourth frame 604 and the processing of transmitting the fourth frame 604.

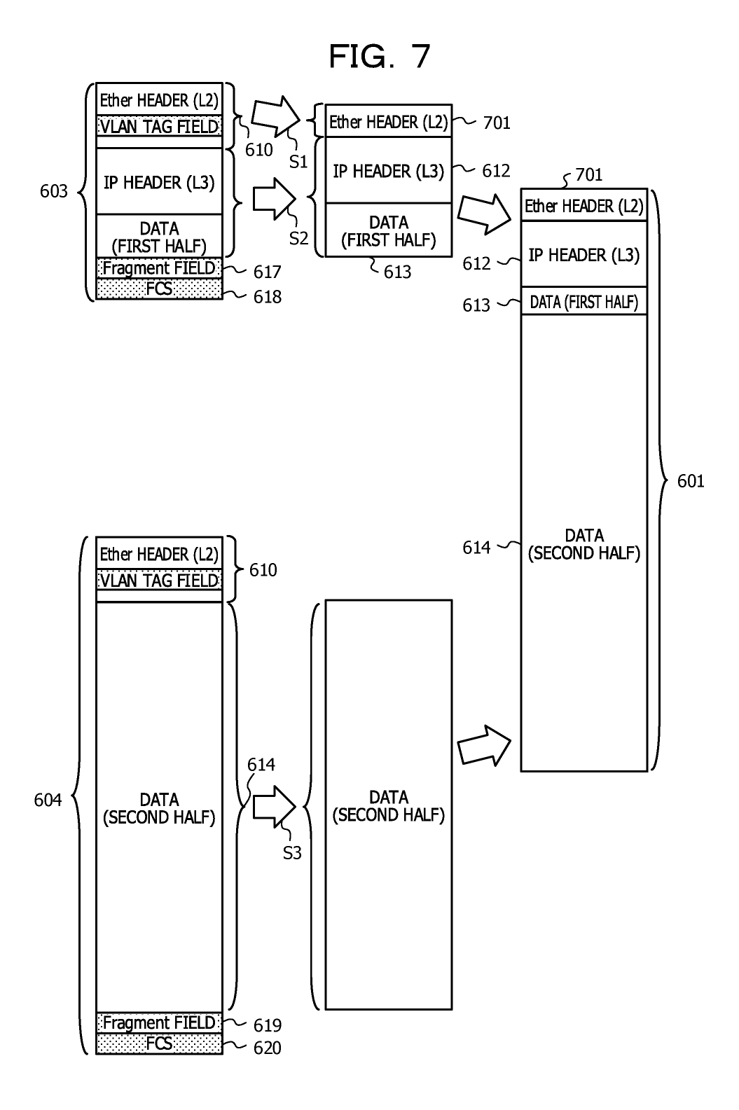

FIG. 7 is a diagram of assistance in explaining an example of detailed operation of the separating unit 321 and the assembling unit 322 within the L2 processing unit 302 in the receiving side device 300 of FIG. 3.

As described earlier in the description of the separating unit 321 in FIG. 3, the separating unit 321 determines whether or not the VLAN tag field storing the given tag protocol identifier described earlier in the description of the transmitting side device 200 of FIG. 2 is added to the Ether header of a frame input from the L1 processing unit 301. Further, the separating unit 321 determines whether or not the above-described Fragment field indicating that the frame is divided is added to a tail end of a payload in the frame.

When the third frame 603 or the fourth frame 604 divided in the operation example of FIG. 6 is input, the Ether header 610 in which the VLAN tag field 611 storing the special number TPID added in the operation example of FIG. 6 is inserted is added to these frames.

Further, the Fragment field 617 or 619 is added to these frames as a result of the operation example of FIG. 6. When the data format of FIG. 4B is adopted, a value 1 indicating that there is a following frame is set as the FLAG field value in the Fragment field 617, and the OFFSET field value=0 (head) is set in the Fragment field 617. In the Fragment field 619, a value 0 indicating that there is no following frame is set as the FLAG field value, and a last address value of the data (first half) 613 is set as the OFFSET field value.

When the data format of FIG. 4C is adopted, a value 1 indicating that the first frame 601 is divided in two pieces is set as the number of divisions field value in the Fragment fields 617 and 619.

When the separating unit 321 thus determines that the VLAN tag field storing the special number TPID is added to the Ether header of the input frame, the separating unit 321 further performs the following determination processing. When the data format of FIG. 4B is adopted, the separating unit 321 performs the following determination processing. When the field value of either FLAG or OFFSET in the Fragment field of the input frame is not zero, the separating unit 321 determines that the input frame is the divided third frame 603 or the divided fourth frame 604, and outputs the input frame to the assembling unit 322. When the data format of FIG. 4C is adopted, the separating unit 321 performs the following determination processing. When the number of divisions field value in the Fragment field of the input frame is one or more, the separating unit 321 determines that the input frame is the divided third frame 603 or the divided fourth frame 604, and outputs the input frame to the assembling unit 322.

As a result, the frame input from the separating unit 321 to the assembling unit 322 in FIG. 3 is the third frame 603 or the fourth frame 604 of low priority, the third frame 603 or the fourth frame 604 being divided as a result of the operation example illustrated in FIG. 6 due to the interruption transmission of the frame of high priority.

The assembling unit 322 performs frame assembly processing using frames whose Fragment fields have the same ID field value among third and fourth frames input from the separating unit 321. Suppose that the respective ID field values in the respective Fragment fields 617 and 619 in the third frame 603 and the fourth frame 604 illustrated in FIG. 7 are the same.

In this case, the assembling unit 322 first detects, as the third frame 603, the frame in which the value of the OFFSET field in the Fragment field 617 is zero (in the case of FIG. 4B) or the value of the order field in the Fragment field 617 is zero (in the case of FIG. 4C). Next, the assembling unit 322 generates an Ether header 701 by deleting the VLAN tag field 611 from the Ether header 610 of the third frame 603 (S1 in FIG. 7). The assembling unit 322 then couples the IP header 612 and the data (first half) 613 stored in the payload of the third frame 603 to the Ether header 701 (S2 in FIG. 7).

Next, the assembling unit 322 detects other frames having set therein the same ID field value as the ID field value stored in the Fragment field 617 of the above-described third frame 603. Further, the assembling unit 322 detects, from among the detected frames, a frame in which the value of the OFFSET field is other than zero (in the case of FIG. 4B) or the value of the order field is one (in the case of FIG. 4C) as the fourth frame 604 corresponding to the above-described third frame 603. The assembling unit 322 then extracts the data (second half) 614 stored in the payload of the fourth frame 604 (S3 in FIG. 7).

The assembling unit 322 reconstructs the first frame 601 by coupling together the Ether header 701, the IP header 612, the data (first half) 613, and the data (second half) 614 extracted in S1, S2, and S3 in FIG. 7.

Thus, in the present embodiment, the first frame 601 may be reconstructed from the divided third and fourth frames 603 and 604 of low priority by merely distinguishing the VLAN tag field and the Fragment field that may be added to input frames. As a result, a processing delay (in the case of a terminating node) or a transmission delay (in the case of a relay node) may be suppressed by reconstructing the first frame 601 from the third and fourth frames 603 and 604.

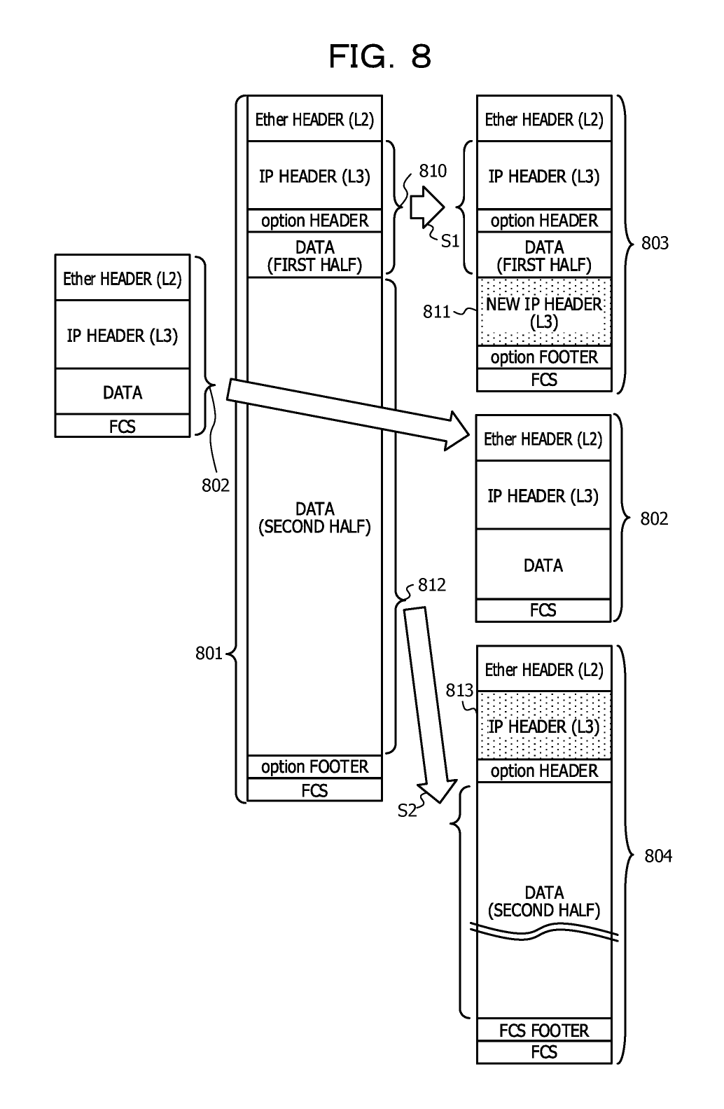

FIG. 8 is a diagram of assistance in explaining operation of a related technology to be compared with the operation examples of the present embodiment in FIG. 6 and FIG. 7. In the operation example of FIG. 6, the first frame 601 is divided into the third frame 603 and the fourth frame 604, and the third frame 603 and the fourth frame 604 are transmitted, due to the occurrence of an opportunity to transmit the second frame 602 of high priority during the transmission of the first frame 601 of low priority. On the other hand, also in the operation example of the related technology in FIG. 8, a first frame 801 is divided into a third frame 803 and a fourth frame 804, and the third frame 803 and the fourth frame 804 are transmitted, due to the occurrence of an opportunity to transmit a second frame 802 of high priority during the transmission of the first frame 801 of low priority. A part 810 including an IP header and data (first half) in a payload of the first frame 801 is divided and stored in a payload of the third frame 803 (S1 in FIG. 8), and data (second half) 812 is divided and stored in a payload of the fourth frame 804 (S2 in FIG. 8).

In the operation example of the related technology in FIG. 8, frame division is applied to an IP packet in the L3 layer rather than to an Ether frame in the L2 layer. For example, when described by taking the example of configuration of the transmitting side device 200 in FIG. 2, division processing is performed in a block corresponding to the L3 transmitting unit 214 within the L3 processing unit 201 rather than the L2 transmitting unit 222 within the L2 processing unit 202.

The L3 transmitting unit in the related technology performs the following processing when an opportunity to transmit an IP packet of high priority within a payload of the second frame 802 comes during the transmission of an IP packet within the payload of the first frame 801 of low priority. During the transmission of the IP packet of the first frame 801, the L3 transmitting unit divides the IP packet of the first frame 801, and thereby converts the IP packet of the first frame 801 into a plurality of fragment packets, for example, an IP packet within the payload of the third frame 803 and an IP packet within the payload of the fourth frame 804. The L3 transmitting unit transmits the IP packet of the second frame 802 of high priority between the transmission of the IP packet of the third frame 803 and the transmission of the IP packet of the fourth frame 804.

At this time, in the related technology, the part 810 including the IP header and the data (first half) divided from the IP packet of the first frame 801 has already been transmitted. It is therefore difficult to indicate that the IP packet of the third frame 803 is a fragment packet by using this IP header. Accordingly, the L3 transmitting unit in the related technology forms a fragment packet at a head by adding, immediately following the already transmitted data 810, a new IP header 811 indicating that the IP packet of the third frame 803 including the already transmitted data 810 is a fragment packet.

On the other hand, at a time of generation of the IP packet of the fourth frame 804 to which the data (second half) 812 divided from the IP packet of the first frame 801 is copied, the L3 transmitting unit in the related technology inserts information about the fragments into an IP header 813 within the IP packet.

An L3 processing unit within a receiving side device in the related technology performs the following processing when receiving the third frame 803 and the fourth frame 804 in which the above-described respective fragment packets are inserted. The L3 processing unit within the receiving side device replaces the IP header in the part 810 including the IP header and the data (first half) included in the fragment packet at the head which fragment packet is extracted from the third frame 803 with the new IP header 811 added immediately following the part 810. The L3 processing unit within the receiving side device reconstructs the original IP packet based on information about the fragments within the substituted new IP header 811 and the information about the fragments within the IP header 813 of the fragment packet extracted from the fourth frame 804.

As described above, in the related technology, the processing of dividing a packet of low priority at a time of the occurrence of an opportunity to transmit a packet of high priority is performed in the L3 layer. In this case, according to the IP protocol, the fragment packets need to be processed based on information about the fragments within an IP header added to each packet. Hence, the related technology needs to add the new IP header 811 for rewriting the already transmitted IP header at the time of transmission of the third frame 803, and involves complex processing of rewriting the IP header, thus correspondingly increasing a delay and decreasing transmission efficiency. The related technology has a precondition that IP be used in the L3 layer, and has a problem of difficulty in dealing with other protocols of the L3 layer. It is difficult to apply the related technology in a case where consideration is given to the application of the related technology to layer 2 switches having processing functions only in the L2 layer.

On the other hand, in the present embodiment of FIG. 6 and FIG. 7, at the time of the transmission of the third frame 603, the Ether header 610 including the already transmitted VLAN tag field 611 does not need to be rewritten, and fragment processing may be performed in the Fragment field 617 at the tail end of the payload.

Hence, the present embodiment does not need the processing of rewriting the Ether header or the like, and does not involve complex processing, so that a transmission delay may be suppressed.

Because control in the L3 layer is not needed, it may be possible to deal with the other protocols of the L3 layer.

Further, a frame dividing system according to the present embodiment may be applied also to layer 2 switches (for example, the Node B (L2SW) 101 in FIG. 1) having processing functions only in the L2 layer.

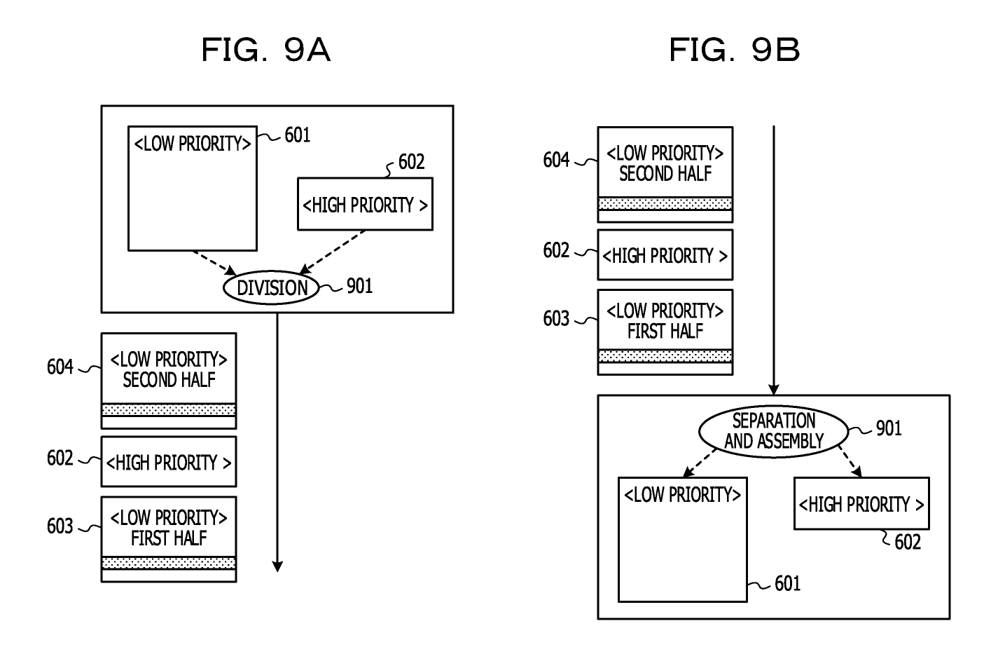

FIG. 9A and FIG. 9B are diagrams of assistance in explaining an example of operation of a terminating device (for example, the Node A (termination) 103 or the Node E (termination) 103 in FIG. 1) to which one embodiment of a communication device is applied.

As described above, according to the present embodiment, it may be possible to dynamically change a priority ratio between low priority frames and high priority frames, suppress erroneous recognition of data as the identifier of a fragment frame, or apply the present embodiment even when there is a node not supporting dynamic division on a path. The application is not limited to cases where layer 3 functions based on IP may be implemented. In addition, the IP header rewriting processing is rendered unnecessary.

At a time of transmission in FIG. 9A, as described earlier with reference to FIG. 6, when an opportunity to transmit a second frame 602 of high priority occurs during the transmission of a first frame 601, the first frame 601 is divided into a third frame 603 and a fourth frame 604 (901 in FIG. 9A). A Fragment field 615 (part of dark color) is added to the third frame 603 and the fourth frame 604. The third frame 603 of low priority, the second frame 602 of high priority, and the fourth frame 604 of low priority are transmitted in this order.

At a time of reception in FIG. 9B, as described earlier with reference to FIG. 7, the third frame 603, the second frame 602 of high priority, and the fourth frame 604 are received in this order. These received frames are separated into the second frame 602 of high priority and the third frame 603 and the fourth frame 604 of low priority. Then, the first frame 601 is assembled from the third frame 603 and the fourth frame 604 (the above is indicated by 902 in FIG. 9B).

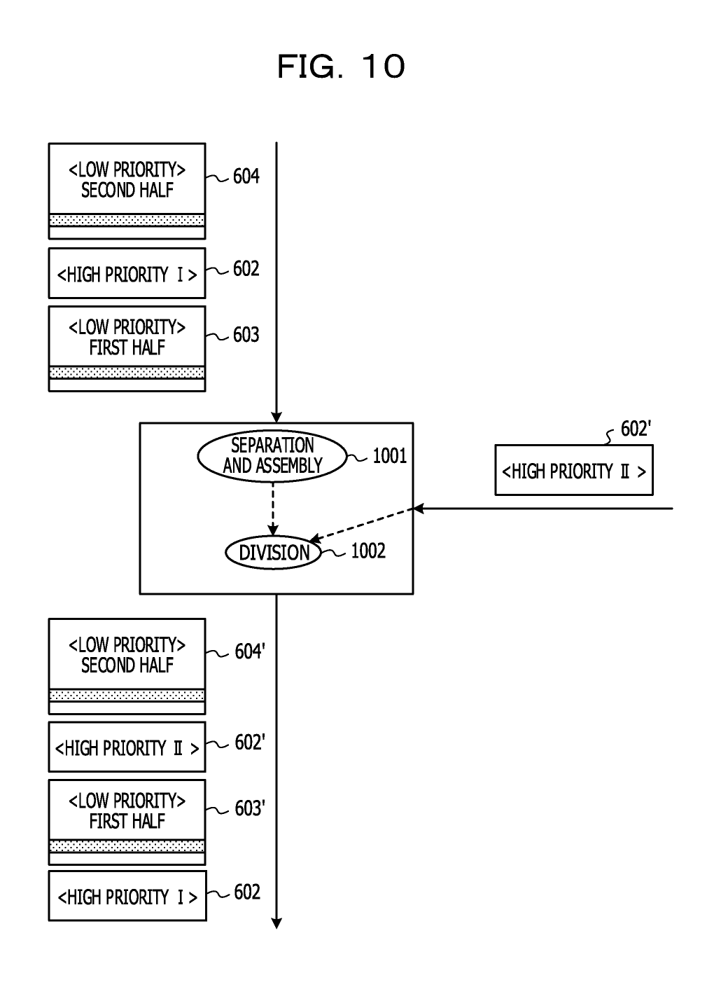

FIG. 10 is a diagram of assistance in explaining an example of operation of a relay device (for example, the Node B (L2SW) 101 or the Node C/D (Router) 102 in FIG. 1) to which one embodiment of a communication device is applied and which is capable of both assembly and division.

In FIG. 10, as in the case of the reception time in FIG. 9B, a divided third frame 603 of low priority, a second frame 602 of high priority I, and a divided fourth frame 604 of low priority are received at an input port in this order. At the input port, as in the case of the reception time in FIG. 9B, these received frames are separated into the undivided second frame 602 of high priority I and the divided third frame 603 and the divided fourth frame 604 of low priority. Then, a first frame 601 (not illustrated) is assembled from the third frame 603 and the fourth frame 604 (the above is indicated by 1001 in FIG. 10).

In FIG. 10, at a time of relay, the second frame 602 of high priority I is first input to a relay unit via the separating unit 321, the selecting unit 323, and the transmitting unit 324 in FIG. 3, and relayed. The assembled first frame 601 is relayed next.

Thereafter, the first frame 601 is output from an output port following the second frame 602 of high priority. Suppose that at this time, an opportunity to transmit a second frame 602′ of high priority II further occurs at the output port. In this case, at the output port, the assembled first frame 601 is divided again into a third frame 603′ and a fourth frame 604′. Then, following the output of the second frame 602 of high priority I, the third frame 603′, the second frame 602′ of high priority II, and the fourth frame 604′ are output in this order.

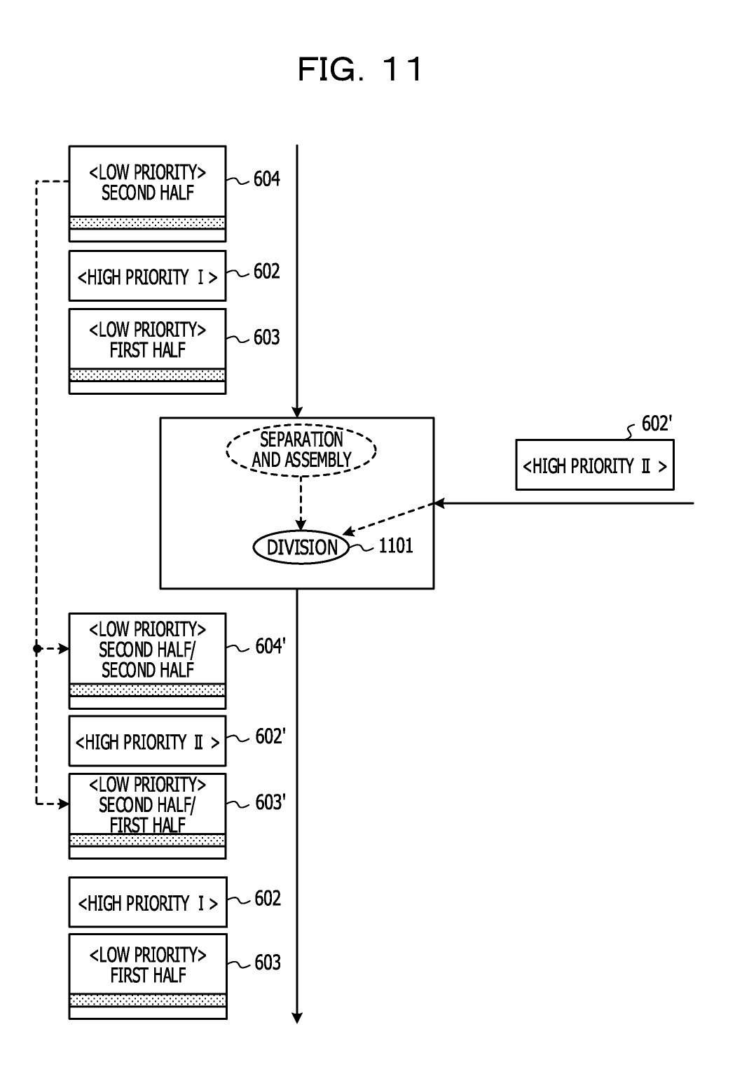

FIG. 11 is a diagram of assistance in explaining an example of operation of a relay device (for example, the Node B (L2SW) 101 or the Node C/D (Router) 102 in FIG. 1) to which one embodiment of a communication device is applied and which is capable of only division.

In FIG. 11, at an input port, a divided third frame 603 of low priority, a second frame 602 of high priority I, and a divided fourth frame 604 of low priority are received in this order.

The relay device of FIG. 11 does not have the function of separating and assembling frames of low priority and high priority. Therefore, these received frames are subjected to relay processing in the relay device as they are.

Thereafter, the frames are output from an output port in order of the third frame 603 including data (first half) 613 of low priority (see FIG. 6), the second frame 602 of high priority I, and the fourth frame 604 including data (second half) 614 of low priority (see FIG. 6).

Here, suppose that an opportunity to transmit a second frame 602′ of high priority II further occurs while the fourth frame 604 is output from the output port. The data (first half) 613 (see FIG. 6), for example, is divided and stored in the third frame 603. The data (second half) 614 (see FIG. 6), for example, is divided and stored in the fourth frame 604. When the opportunity to transmit the second frame 602′ of high priority II occurs in the output timing of the fourth frame 604, the data (second half) 614 of the fourth frame 604 is further divided into data (second half/first half) and data (second half/second half). Then, the fourth frame 604 of low priority is converted into a third frame 603′ of low priority, the third frame 603′ storing the data (second half/first half), and is output following the second frame 602 of high priority I. The newly generated second frame 602′ of high priority II is thereafter output. Then, a fourth frame 604′ of low priority, the fourth frame 604′ storing the data (second half/second half), is generated and output.

In this case, offset values at the time of input to the relay device are set as they are in respective OFFSET fields in Fragment fields 617 (parts of dark color) (see FIG. 6) added to the third frame 603 and the new third frame 603′. A total size of the data (first half) 613 of the third frame 603 and the data (second half/first half) of the new third frame 603′ is set in an OFFSET field in a Fragment field 619 (part of dark color) added to the new fourth frame 604′.

In respective ID fields in the respective Fragment fields 617 and 619 of the third frame 603, the new third frame 603′, and the new fourth frame 604′, new identification values are set again to support replacement of a transmission source MAC address at a default gateway or the like (the above is indicated by 1101 in FIG. 11).

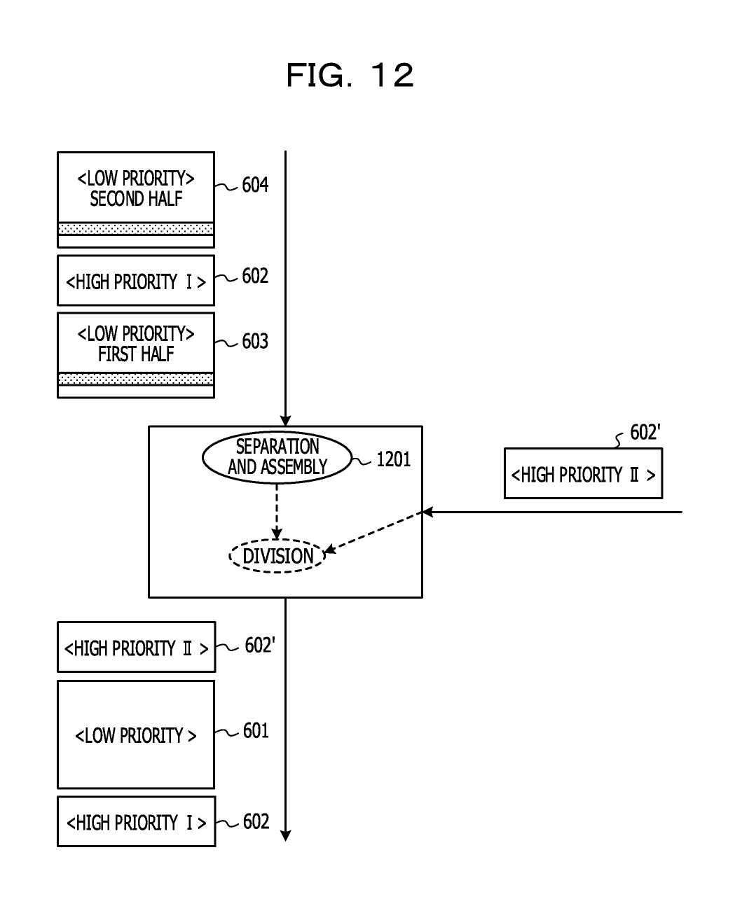

FIG. 12 is a diagram of assistance in explaining an example of operation of a relay device (for example, the Node B (L2SW) 101 or the Node C/D (Router) 102 in FIG. 1) to which one embodiment of a communication device is applied and which is capable of only assembly.

In FIG. 12, at a time of relay, as in the case of the reception time in FIG. 9B, a divided third frame 603 of low priority, a second frame 602 of high priority I, and a divided fourth frame 604 of low priority are received at an input port in this order. As in the case of the reception time in FIG. 9B, at the input port, these received frames are separated into the undivided second frame 602 of high priority I and the divided third frame 603 and the divided fourth frame 604 of low priority. Then, a first frame 601 (not illustrated) is assembled from the third frame 603 and the fourth frame 604 (the above is indicated by 1201 in FIG. 12).

In FIG. 12, at the time of relay, the second frame 602 of high priority I is first input to a relay unit via the separating unit 321, the selecting unit 323, and the transmitting unit 324 in FIG. 3, and is relayed. The assembled first frame 601 is relayed next.

Thereafter, the first frame 601 is output from an output port following the second frame 602 of high priority. Suppose that at this time, an opportunity to transmit a second frame 602′ of high priority II further occurs at the output port. The relay device of FIG. 12 does not have the function of dividing a frame of low priority. Therefore, the second frame 602′ of high priority II is transmitted after completion of the output of the first frame 601 of low priority which first frame is being output.

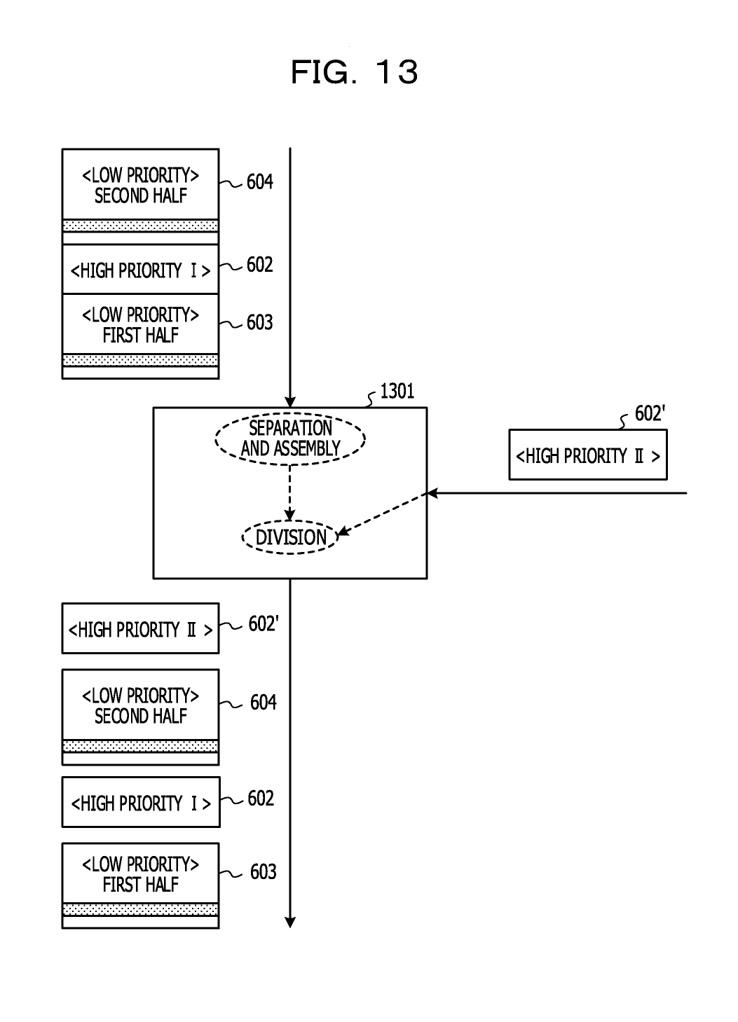

FIG. 13 is a diagram of assistance in explaining an example of operation of a relay device to which one embodiment of a communication device is not applied. A relay device 1301 of FIG. 13 has neither the function of dividing a frame of low priority nor the function of separating and assembling frames of low priority and high priority according to the present embodiment. Therefore, the relay device 1301 is set to communicate the special number TPID of the VLAN tag field added to a frame of low priority which frame is divided according to the present embodiment.

In FIG. 13, at an input port, a divided third frame 603 of low priority, a second frame 602 of high priority I, and a divided fourth frame 604 of low priority are received in this order.

The relay device 1301 of FIG. 13 does not have the function of separating and assembling frames of low priority and high priority. Therefore, these received frames are subjected to relay processing in the relay device 1301 as they are.

Thereafter, the frames are output from an output port in order of the third frame 603 including data (first half) 613 of low priority (see FIG. 6), the second frame 602 of high priority I, and the fourth frame 604 including data (second half) 614 of low priority (see FIG. 6). Suppose that at this time, an opportunity to transmit a second frame 602′ of high priority II further occurs at the output port. The relay device 1301 of FIG. 13 does not have the function of dividing a frame of low priority. Therefore, the second frame 602′ of high priority II is transmitted after completion of the output of the fourth frame 604 of low priority which fourth frame is being output.

As described above, as in FIG. 9A and FIG. 9B, the present embodiment may be compatible with a terminating device such as the Node A (termination) 103 or the Node E (termination) 103 in FIG. 1. The present embodiment may be versatilely compatible with various forms of relay devices such as the Node B (L2SW) 101 and the Node C/D (Router) 102 in FIG. 1. For example, it may be possible to deal with each of cases where the relay device has both the function of dividing a frame of low priority and the function of separating and assembling frames of low priority and high priority according to the present embodiment as in FIG. 10 and cases where the relay device has only one function as in FIG. 11 and FIG. 12. Further, even when the relay device has neither of the above-described two functions as in FIG. 13, frames of low priority which frames are divided according to the present embodiment may be communicated without any problem.

Thus, according to the present embodiment, it may be possible to provide a versatile method of suppressing the occurrence of a delay in transmission of data having high priority.

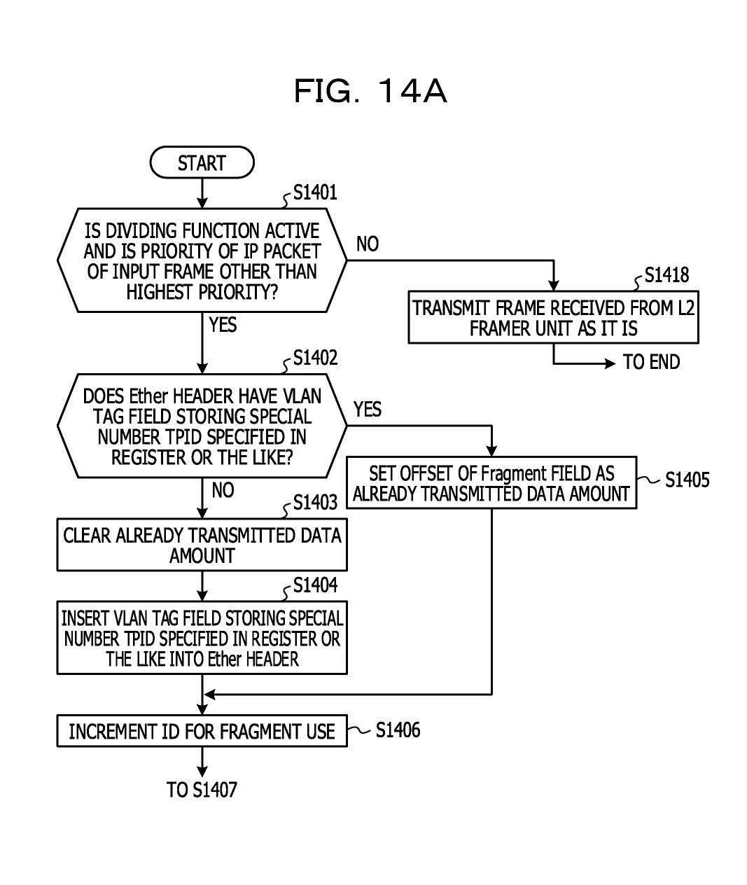

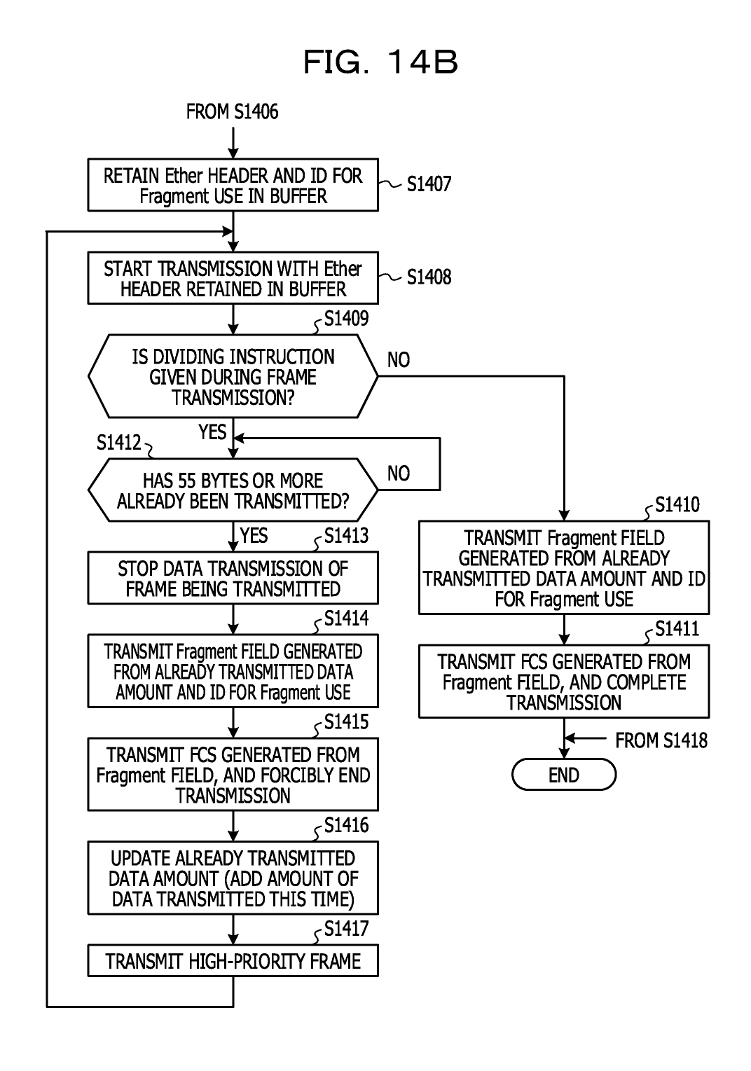

FIG. 14A and FIG. 14B are flowcharts illustrating an example of processing of the L2 transmitting unit 222 within the L2 processing unit 202 in the transmitting side device 200 of FIG. 2.

The L2 transmitting unit 222 determines whether or not the dividing function is set active in the own device and the priority of an IP packet stored in a payload of an input frame is other than highest priority (S1401 in FIG. 14A). The case of FIG. 9A, FIG. 10, or FIG. 11 corresponds to a case where the dividing function is set active in the own device. The priority of the IP packet stored in the payload of the input frame is notified from the L3 monitoring unit 223 in FIG. 2.

When the dividing function is set active in the own device and the priority of the IP packet of the input frame is other than the highest priority (in a case of YES in the determination of S1401 in FIG. 14A), the L2 transmitting unit 222 performs the following processing. The L2 transmitting unit 222 determines whether or not a VLAN tag field 611 storing a special number TPID specified in advance in a register or the like within the own device is added to an Ether header of the input frame (S1402 in FIG. 14A).

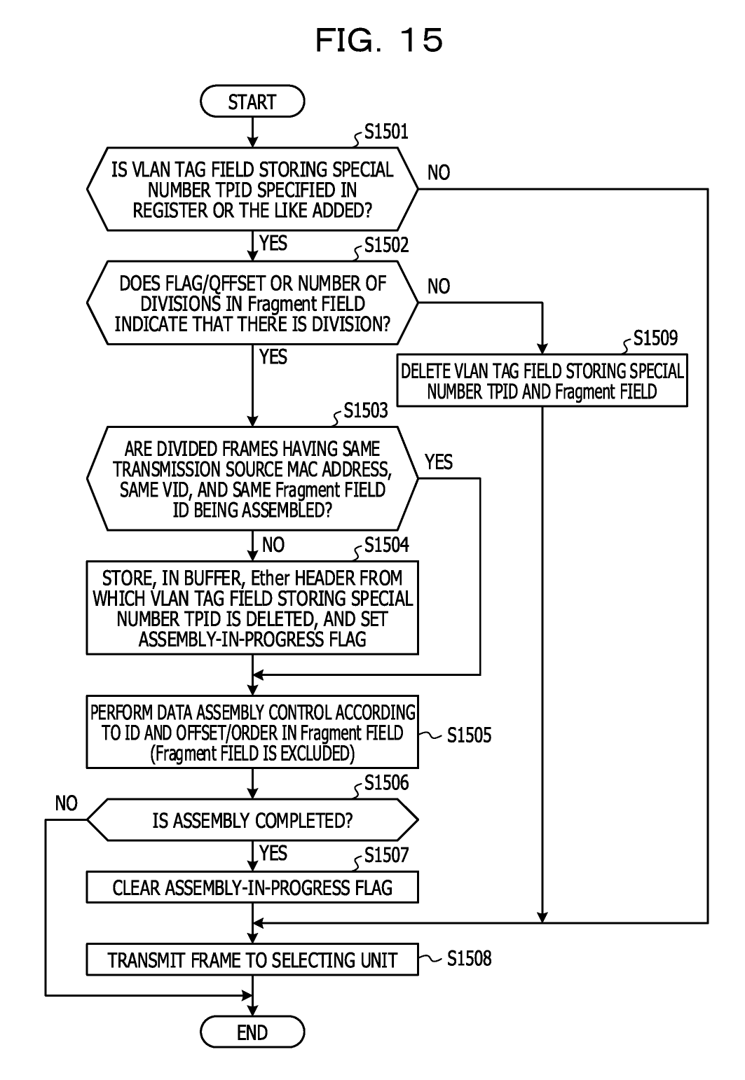

When the own device is a terminating device and a frame that is not of the highest priority is transmitted as in FIG. 9A, the object frame is the first frame 601 illustrated in FIG. 6, the first frame 601 being generated first in the own device. In this case, at first, the VLAN tag field 611 is not added to the Ether header 610 of this frame. When the own device is a relay device, already divided received third and fourth frames 603 and 604 of low priority are assembled (1001 in FIG. 10), and then relaying and transmission are performed, as in FIG. 10, the object frame is the first frame 601 illustrated in FIG. 6. Also in this case, the VLAN tag field 611 is not added to the Ether header 610 of the first frame 601. Further, when the own device is a relay device and a received undivided first frame 601 of low priority is relayed and transmitted as in FIG. 10, the following control is performed. First, at a time of reception, the VLAN tag field 611 and the Fragment field 615 are deleted from the Ether header 610 of the first frame 601 (see S1509 in FIG. 15 to be described later). Hence, when this first frame 601 is input to the output port after being relayed, the VLAN tag field 611 is not added to the Ether header 610 of the first frame 601. The determination of S1402 is NO in any of the above cases.

On the other hand, when the own device is a relay device, received frames are relayed without being assembled, and a frame that is not of the highest priority is thereafter transmitted, as in FIG. 11, the input frame is the following frame. The input frame is either the undivided first frame 601 of low priority, the first frame 601 being illustrated in FIG. 6 and including the Ether header 610 to which the VLAN tag field 611 is already added, or the already divided third frame 603 of low priority, or the fourth frame 604. In this case, the determination of S1402 is YES.

When the determination of S1402 is NO, the L2 transmitting unit 222 clears an already transmitted data amount stored as a variable in an internal memory, for example (S1403 in FIG. 14A).

Next, the L2 transmitting unit 222 inserts the VLAN tag field 611 storing the special number TPID specified in advance in the register or the like within the own device to the Ether header 610 of the input first frame 601 (S1404 in FIG. 14A).

When the determination of S1402 is YES, on the other hand, the following processing is performed. The L2 transmitting unit 222 extracts an OFFSET field value from the Fragment field 615, 617, or 619 added to the input first frame 601, the input third frame 603, or the input fourth frame 604. Then, the L2 transmitting unit 222 sets the OFFSET field value as the already transmitted data amount, which is stored as a variable in the internal memory, for example (the above is illustrated in S1405 in FIG. 14A).

After the processing of S1404 or S1405 described above, the L2 transmitting unit 222 increments an ID field value to be set in a Fragment field, the ID field value being stored as a variable in the internal memory, for example (S1406 in FIG. 14A). This ID field value will hereinafter be referred to as an “ID for Fragment use.”

The L2 transmitting unit 222 retains the Ether header 610 in which the VLAN tag field 611 is inserted and the ID for Fragment use which ID is updated in S1406 in a not particularly illustrated internal buffer (S1407 in FIG. 14B). The Ether header 610 is generated in S1404 in the case where the determination of S1402 is NO. In the case where the determination of S1402 is YES, the Ether header 610 is the Ether header 610 in which the VLAN tag field 611 added to the input first frame 601, the input third frame 603, or the input fourth frame 604 is inserted.

Next, the L2 transmitting unit 222 replaces the Ether header in the input frame with the Ether header 610 retained in the buffer in S1407, and thereafter starts transmitting the frame (S1408 in FIG. 14B). Transmitted are the substituted Ether header 610 in which the VLAN tag field 611 is inserted and the IP packet within the following payload.

The L2 transmitting unit 222 determines whether or not an instruction to divide the frame of low priority due to the occurrence of an opportunity to transmit a second frame 602 of high priority is notified from the L3 monitoring unit 223 during the transmission of the frame (S1409 in FIG. 14B).

When the determination of S1409 is NO after completion of frame transmission to a tail end of the payload without the occurrence of an opportunity to transmit a second frame 602 of high priority (without the determination of S1409 becoming YES), the L2 transmitting unit 222 performs the following processing. The L2 transmitting unit 222 generates a Fragment field to be added following the payload of the transmitted frame from the already transmitted data amount retained in the internal memory and the ID for Fragment use which ID is retained in the buffer. Then, the L2 transmitting unit 222 transmits the generated Fragment field following the payload (S1410 in FIG. 14B). In the present embodiment, the format of FIG. 4B is used as the data format of the Fragment field.

In S1410, the L2 transmitting unit 222 sets the ID for Fragment use, which ID is incremented in S1406 and retained in the buffer in S1407, in the ID field (see FIG. 4B) of the generated Fragment field.

Next, when the above-described determination of S1402 is NO and the determination of S1409 is NO without once becoming YES, it means that the input first frame 601 of low priority is transmitted without being divided. In this case, in S1410, the L2 transmitting unit 222 generates the Fragment field 615 in which the already transmitted data amount cleared in S1403 is set in the OFFSET field. Then, the L2 transmitting unit 222 transmits the generated Fragment field 615 following the payload of the transmitted first frame 601. Because the transmitted first frame 601 is not divided, the value of the OFFSET field is a cleared value 0.

When the above-described determination of S1402 is YES and the determination of S1409 is NO without once becoming YES, on the other hand, it means that the input third frame 603 or the input fourth frame 604 is relayed and transmitted without being redivided. In this case, in S1405 described above, the L2 transmitting unit 222 extracts the value of the OFFSET field of the Fragment field 617 or 619 of the input third frame 603 or the input fourth frame 604 as the already transmitted data amount. In S1410, the L2 transmitting unit 222 generates the Fragment field 617 or 619 in which the already transmitted data amount is set in the OFFSET field. Then, the L2 transmitting unit 222 transmits the generated Fragment field 617 or 619 following the payload of the transmitted third frame 603 or the transmitted fourth frame 604.

The L2 transmitting unit 222 further sets the value of the FLAG field (see FIG. 4B) of the Fragment field 615, 617, or 619 when the frame is input in the FLAG field of the Fragment field 615, 617, or 619. The L2 transmitting unit 222 sets the size of the payload of the frame in the TOTAL_SIZE field (see FIG. 4B) of the Fragment field 615, 617, or 619.

After transmitting the above-described Fragment field, the L2 transmitting unit 222 calculates and generates an FCS from the Ether header, the payload, and the Fragment field of the transmitted frame. Then, the L2 transmitting unit 222 transmits the generated FCS following the above-described Fragment field, and ends the frame transmission (S1411 in FIG. 14B).

Description will be made later of a case where the determination of S1409 once becomes YES and thereafter the determination of S1409 for a second time becomes NO, and then S1410 and S1411 described above are performed.

When an opportunity to transmit a second frame 602 of high priority occurs during the transmission of the frame of low priority, and thus the determination of S1409 becomes YES, the L2 transmitting unit 222 transmits up to 55 bytes of the frame currently being transmitted (the determination of S1412 in FIG. 14B is repeatedly NO). The first 55 bytes becomes the third frame 603 or 603′ transmitted after being divided from the first frame 601 or redivided from the fourth frame 604 (see FIG. 9A, FIG. 10, or FIG. 11). The “third frame 603 or 603” will hereinafter be written as the “third frame 603 or the like.”

When the transmission of the first 55 bytes is completed and thus the determination of S1412 becomes YES, the L2 transmitting unit 222 stops the data transmission of the third frame 603 or the like being transmitted (S1413 in FIG. 14B).

The L2 transmitting unit 222 generates a Fragment field 617 to be added following the payload of the transmitted third frame 603 or the like from the already transmitted data amount retained in the internal memory and the ID for Fragment use which ID is retained in the buffer. Then, the L2 transmitting unit 222 transmits the generated Fragment field 617 following the payload of the divided and transmitted third frame 603 or the like (S1414 in FIG. 14B). This processing is similar to that of S1410 described above in FIG. 14B. However, the L2 transmitting unit 222 sets, in the FLAG field of the Fragment field 617, a value 1 indicating that there is a following divided frame. The L2 transmitting unit 222 sets the value of data size of the payload of the frame before the division or the redivision in the TOTAL_SIZE field of the Fragment field 617.

After transmitting the above-described Fragment field 617, the L2 transmitting unit 222 calculates and generates an FCS from the Ether header 610, the payload, and the Fragment field 617 of the transmitted third frame 603 or the like. Then, the L2 transmitting unit 222 transmits the generated FCS following the above-described Fragment field 617, and forcibly ends the transmission of the third frame 603 or the like (S1415 in FIG. 14B).

The L2 transmitting unit 222 updates the above-described already transmitted data amount by adding the amount of transmitted data of the third frame 603 or the like transmitted this time to the already transmitted data amount retained in the memory (S1416 in FIG. 14B).

Thereafter, following the transmission of the above-described third frame 603 or the like, the L2 transmitting unit 222 transmits the second frame 602 of high priority, the opportunity to transmit the second frame 602 having occurred (S1417 in FIG. 14B).

Next, returning to the processing of S1408, the L2 transmitting unit 222 transmits a divided or redivided fourth frame 604 or 604′ for a 56th byte and subsequent bytes whose transmission is stopped in S1413 (see FIG. 9A, FIG. 10, or FIG. 11). The “fourth frame 604 or 604” will hereinafter be written as the “fourth frame 604 or the like.”

In the transmission of the fourth frame 604 or the like, the L2 transmitting unit 222 first starts transmitting the Ether header 610 in which the VLAN tag field 611 is inserted, the Ether header 610 being retained in the buffer and similar to that of the third frame 603 or the like (S1408 in FIG. 14B).

After transmitting the Ether header 610, the L2 transmitting unit 222 transmits the 56th byte and the subsequent data described above as the payload of the fourth frame 604 or the like. When the determination of S1409 is NO after completion of the transmission of the fourth frame 604 or the like to a tail end of the payload without the reoccurrence of an opportunity to transmit a second frame 602 of high priority during the transmission of the payload, the L2 transmitting unit 222 performs the following processing.

The L2 transmitting unit 222 generates a Fragment field to be added following the payload of the transmitted frame from the already transmitted data amount retained in the internal memory and the ID for Fragment use which ID is retained in the buffer. Then, the L2 transmitting unit 222 transmits the generated Fragment field following the payload of the fourth frame 604 or the like (S1410 in FIG. 14B).

In this case, the L2 transmitting unit 222 generates the Fragment field 619 in which the already transmitted data amount updated due to the division in S1416 described above is set in the OFFSET field. Then, the L2 transmitting unit 222 transmits the generated Fragment field 619 following the payload of the transmitted fourth frame 604 or the like.

The L2 transmitting unit 222 further sets a value 0 indicating that there is no following divided frame in the FLAG field (see FIG. 4B) of the Fragment field 619. The L2 transmitting unit 222 sets a value obtained by adding the data size of the payload of the present fourth frame 604 to the above-described already transmitted data amount in the TOTAL_SIZE field (see FIG. 4B) of the Fragment field 619.

After transmitting the Fragment field 619, the L2 transmitting unit 222 calculates and generates an FCS from the Ether header 610, the payload, and the Fragment field 619 of the transmitted fourth frame 604 or the like. Then, the L2 transmitting unit 222 transmits the generated FCS following the above-described Fragment field 619, and ends the transmission of the fourth frame 604 or the like (S1411 in FIG. 14B).

FIG. 15 is a flowchart illustrating an example of processing of the separating unit 321 and the assembling unit 322 within the L2 processing unit 302 in the receiving side device 300 of FIG. 3.

First, the separating unit 321 determines whether or not a VLAN tag field 611 storing a special number TPID specified in advance in a register or the like within the own device is added to the Ether header of an input frame (S1501 in FIG. 15).

Next, when the determination of S1501 is NO, the separating unit 321 skips processing of the assembling unit 322 from S1502 to S1507, and proceeds to processing of S1508. Here, the separating unit 321 transmits the input frame to the selecting unit 323 within the L2 processing unit 302 in FIG. 3. This processing corresponds to an operation in which when a second frame 602 of high priority is received, the separating unit 321 transmits the second frame 602 to the selecting unit 323, as described earlier in the description of the separating unit 321 in FIG. 3.

When the determination of S1501 is YES, the separating unit 321 performs the following processing. The separating unit 321 determines whether or not the field of FLAG/OFFSET (in the case of FIG. 4B) or the field of number of divisions (in the case of FIG. 4C) in the Fragment field of the input frame indicates that there is division (S1502 in FIG. 15). In the case of the format of FIG. 4B, when a value 0 indicating that there is no following frame is set in the FLAG field of the above-described Fragment field 615 and the value of the OFFSET field is zero, the separating unit 321 determines that there is no division, and thus makes a determination of NO in S1502. In the case of the format of FIG. 4C, when the value of the number of divisions field of the above-described Fragment field 615 is zero, the separating unit 321 determines that there is no division, and thus makes a determination of NO in S1502.

The case of the determination of NO in S1502 is a case where a first frame 601 is received without being divided. In this case, the separating unit 321 deletes the VLAN tag field 611 storing the special number TPID from the Ether header 610 of the first frame 601, and further deletes the Fragment field 615 added to a tail end of a payload of the first frame 601. Thereafter, the separating unit 321 proceeds to the processing of S1508. As a result, a first frame 601 obtained by deleting the VLAN tag field 611 and the Fragment field 615 from the received undivided first frame 601 is transferred from the separating unit 321 to the selecting unit 323 within the L2 processing unit 302 in FIG. 3.

A case of a determination of YES in S1502 is a case where a third frame 603 or a fourth frame 604 is received. In this case, control is transferred to the assembling unit 322.

The assembling unit 322 obtains respective field values of a transmission source MAC address in the Ether header 610, a VID in the VLAN tag field 611, and an ID in the Fragment field 617 or 619 from the received third frame 603 or the received fourth frame 604. The assembling unit 322 determines whether or not an assembly-in-progress flag associated with the same values as the transmission source MAC address, the VID, and the Fragment ID obtained is set in an internal memory (S1503 in FIG. 15).

When the determination of S1503 is NO, the assembling unit 322 stores, in a buffer, the Ether header 610 from which the VLAN tag field 611 storing the special number TPID is deleted. The assembling unit 322 stores, in the memory, the Ether header 610 in the buffer and the assembly-in-progress flag associated with the transmission source MAC address, the VID, and the Fragment ID obtained in S1503 (the above is illustrated in S1504 in FIG. 15).

When the determination of S1503 is YES, the assembling unit 322 skips the processing of S1504.

The assembling unit 322 next performs assembly control according to the respective field values of the ID and OFFSET (FIG. 4B) or order (FIG. 4C) in the Fragment field 617 or 619 of the received third frame 603 or the received fourth frame 604 (S1505 in FIG. 15). This assembly control is as described earlier in the description of the operation example of FIG. 7.

Thereafter, the assembling unit 322 determines whether or not assembly is completed (S1506 in FIG. 15).

When the determination of S1506 is NO, the assembling unit 322 ends the present assembly processing as it is.

When the determination of S1506 is YES, the assembling unit 322 clears the assembly-in-progress flag and the information associated therewith in the memory (S1507 in FIG. 15).

Then, the assembling unit 322 transmits the first frame 601 whose assembly is completed (see FIG. 7) to the selecting unit 323 within the L2 processing unit 302 in FIG. 3 (S1508), and ends the present assembly processing.

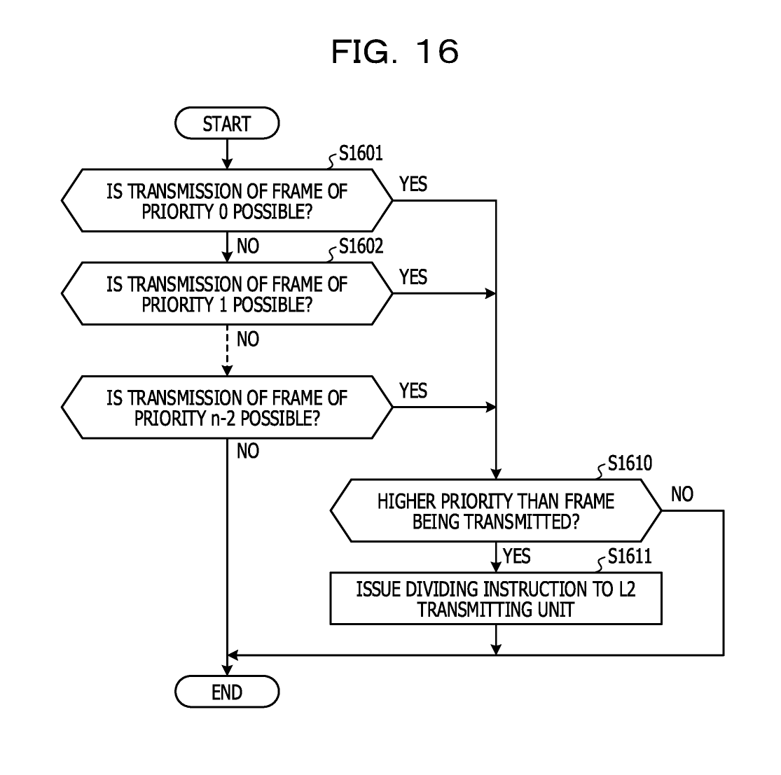

FIG. 16 is a flowchart illustrating an example of processing of an L3 monitoring unit in a case where there are three or more priority classes. The L3 monitoring unit described with reference to FIG. 16 may be the L3 monitoring unit 223 depicted in FIG. 2. Now, suppose that n is the number of priority classes, and that priority is decreased in order of priority 0>priority 1> . . . >priority n−1.

The L3 monitoring unit 223 performs the following series of determination processing by inquiring of the L3 transmitting unit 214 within the L3 processing unit 201 in FIG. 2.

The L3 monitoring unit 223 first determines whether or not the transmission of a frame of priority 0 is possible (S1601 in FIG. 16).

When the determination of S1601 is NO, the L3 monitoring unit 223 determines whether or not the transmission of a frame of priority 1 is possible (S1602 in FIG. 16).

The L3 monitoring unit 223 thereafter performs similar processing until the L3 monitoring unit 223 determines whether or not the transmission of a frame of priority n−2 is possible. When the number of priority classes is n=2, S1602 and subsequent steps do not exist, and only the determination processing of S1601 is performed.

When one of determinations in the priority determination processing of S1601, S1602, . . . is YES, the L3 monitoring unit 223 determines whether or not the priority of the frame whose transmission is possible is higher than the priority of a frame currently being transmitted (S1610 in FIG. 16).

When the determination of S1610 is YES, a dividing instruction is issued to the L2 transmitting unit 222 (S1611 in FIG. 16). As a result, the determination of S1409 becomes YES in the processing of the flowchart of FIG. 14B which processing is performed by the L2 transmitting unit 222 as described earlier.

When the determination of S1610 is NO, the processing of S1611 is skipped, and thus no dividing instruction is issued.

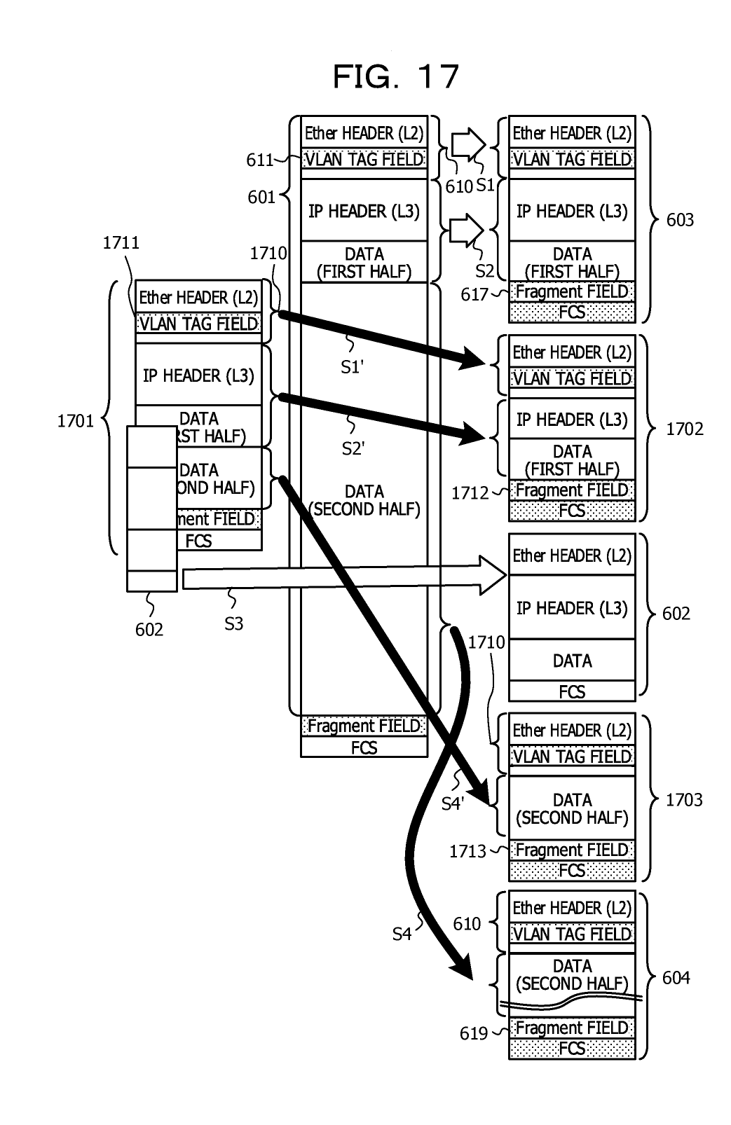

FIG. 17 is a diagram of assistance in explaining an example of detailed operation of the L2 transmitting unit 222 within the L2 processing unit 202 in the transmitting side device 200 of FIG. 2 based on the flowcharts of FIG. 16, FIG. 14A and FIG. 14B in a case where there are three priority classes. In FIG. 17, parts identified by the same reference numerals or symbols as in the operation example of FIG. 6 represent operations similar to those of FIG. 6.

Now, suppose that an opportunity to transmit a fifth frame 1701 of medium priority occurs during processing of transmitting a first frame 601 of low priority, and that a dividing instruction is notified from the L3 monitoring unit 223 in FIG. 2 (the determination of S1602 in FIG. 16 is YES, the determination of S1610 is YES, and the processing proceeds to S1611). As a result, the determination of S1409 in FIG. 14B becomes YES. Accordingly, as described earlier, a third frame 603 converted from the first frame 601 is transmitted. At this time, the above-described specific TPID is set in a VLAN tag field 611 within an Ether header 610 of the third frame 603 that initially starts to be transmitted as the first frame 601 (S1 in FIG. 17). In the VLAN tag field 611, a value 0 indicating lowest priority is set as the value of a PCP field. Further, a first ID field value=0 set in S1406 is set in a Fragment field 617 of the third frame 603 in S1414 in FIG. 14B, for example. A FLAG field value=1 indicating that there is a following divided frame is set in the Fragment field 617 of the third frame 603 in S1414 in FIG. 14B. Further, a first half part (IP header plus data (first half)) of a payload of the first frame 601 is stored in a payload of the third frame 603 (S2 in FIG. 17).

After the transmission of the third frame 603, processing of transmitting the fifth frame 1701 of medium priority for which frame the dividing instruction is generated is performed in S1417 in FIG. 14B. At this time, the L2 transmitting unit 222 calls and performs the transmission processing in the flowchart of FIG. 14B as recursive processing. The fifth frame 1701 of medium priority is not a frame of highest priority. Therefore, the determination of S1401 in FIG. 14A is YES, and processing similar to that in the case of a frame of low priority is performed recursively. As a result, the processing of transmitting the fifth frame 1701 is started. Suppose that at this time, during the transmission, a dividing instruction is further notified from the L3 monitoring unit 223 in FIG. 2 due to further occurrence of an opportunity to transmit a second frame 602 of high priority (the determination of S1601 in FIG. 16 is YES, the determination of S1610 is YES, and the processing proceeds to S1611).

As a result, the determination of S1409 is YES in the transmission processing of FIG. 14B which processing is performed recursively for the frame of medium priority. As a result, a part of the fifth frame 1701 whose transmission is already started is transmitted as a new third frame 1702. At this time, an Ether header 1710 in which a VLAN tag field 1711 of the fifth frame 1701 whose transmission is already started is inserted is used as it is as an Ether header of the new third frame 1702 (S1′ in FIG. 17). In the VLAN tag field 1711, the same specific TPID as in the case of low priority is set, and a value 1 indicating medium priority is set in a PCP field. Further, a first half part (IP header plus data (first half)) of a payload of the fifth frame 1701 is stored in a payload of the new third frame 1702 (S2′ in FIG. 17). Further, an ID field value=1 incremented in S1406 is set in a Fragment field 1712 of the new third frame 1702 in S1414 in FIG. 14B, for example. A FLAG field value=1 indicating that there is a following divided frame is set in the Fragment field 1712 in S1414 in FIG. 14B.

After the transmission of the new third frame 1702, processing of transmitting the second frame 602 of high priority for which frame the dividing instruction is generated is performed in S1417 in FIG. 14B. Also at this time, the L2 transmitting unit 222 calls and performs the transmission processing in the flowchart of FIG. 14B as recursive processing. The second frame 602 of high priority is a frame of highest priority. Therefore, the determination of S1401 in FIG. 14A is NO. As a result, the L2 transmitting unit 222 transmits the second frame 602 of high priority, the second frame 602 being received from the L2 framer unit 221, as it is in S1418 in FIG. 14A (S3 in FIG. 17).

After the transmission of the second frame 602 of high priority, S1408, S1409, S1410, and S1411 are performed in the transmission processing of FIG. 14 which processing is recursively performed for the frame of medium priority. As a result, a new fourth frame 1703 divided from the fifth frame 1701 is generated and transmitted. At this time, an Ether header 1710 in which the same VLAN tag field 1711 as added to the new third frame 1702 is inserted is added to the new fourth frame 1703 in S1408 in FIG. 14B. A second half part (data (second half)) of the payload of the fifth frame 1701 is stored in a payload of the new fourth frame 1703 (S4′ in FIG. 17). Further, an ID field value=1 incremented in S1406 is set to a Fragment field 1713 of the new fourth frame 1703 in S1410 in FIG. 14B, for example. This value is the same as the ID field value added to the Fragment field 1712 of the new third frame 1702 divided from the fifth frame 1701. Hence, the new third frame 1702 and the new fourth frame 1703 may be identified as frames divided from the same fifth frame 1701 in S1503 in the reception processing of FIG. 15 at the receiving side device 300. A FLAG field value=0 indicating that there is no following divided frame is set in the Fragment field 1713 of the new fourth frame 1703 in S1410 in FIG. 14B.

When the transmission processing of FIG. 14B which processing is performed recursively for the frame of medium priority is ended, the processing of S1417 in FIG. 14B which processing is performed for the frame of low priority is ended. Next, S1408, S1409, S1410, and S1411 are performed in the transmission processing of FIG. 14B which processing is performed for the frame of low priority. As a result, a fourth frame 604 divided from the first frame 601 is generated and transmitted. At this time, an Ether header 610 in which the same VLAN tag field 611 as added to the third frame 603 is inserted is added to the fourth frame 604 in S1408 in FIG. 14B. A second half part (data (second half)) of the payload of the first frame 601 is stored in a payload of the fourth frame 604 (S4 in FIG. 17). Further, the ID field value=0 first set in S1406 is set in a Fragment field 619 of the fourth frame 604 in S1410 in FIG. 14B, for example. This value is the same as the ID field value added to the Fragment field 617 of the third frame 603 divided from the first frame 601. Hence, the third frame 603 and the fourth frame 604 may be identified as frames divided from the same first frame 601 in S1503 in the reception processing of FIG. 15 at the receiving side device 300. A FLAG field value=0 indicating that there is no following divided frame is set in the Fragment field 619 of the fourth frame 604 in S1410 in FIG. 14B.

When the transmission processing of FIG. 14B which processing is performed for the frame of low priority is ended, the transmission processing for the frames of all of the priorities is ended.

FIG. 17 represents an example of operation in a case where there are three priority classes. However, even when the number of priority classes is further increased, control for each priority may be performed based on the processing of the flowcharts of FIG. 16, FIG. 14A and FIG. 14B.

In processing in the separating unit 321 and the assembling unit 322 within the L2 processing unit 302 in the receiving side device 300 of FIG. 3, it is possible to deal with a plurality of priorities by the processing of the flowchart of FIG. 15. In divided frames of different priorities, different values for the respective priorities are set as ID values in Fragment fields 615. Therefore, original frames may be assembled from the divided frames of the respective priorities as a result of the determination processing of S1503 in FIG. 15.

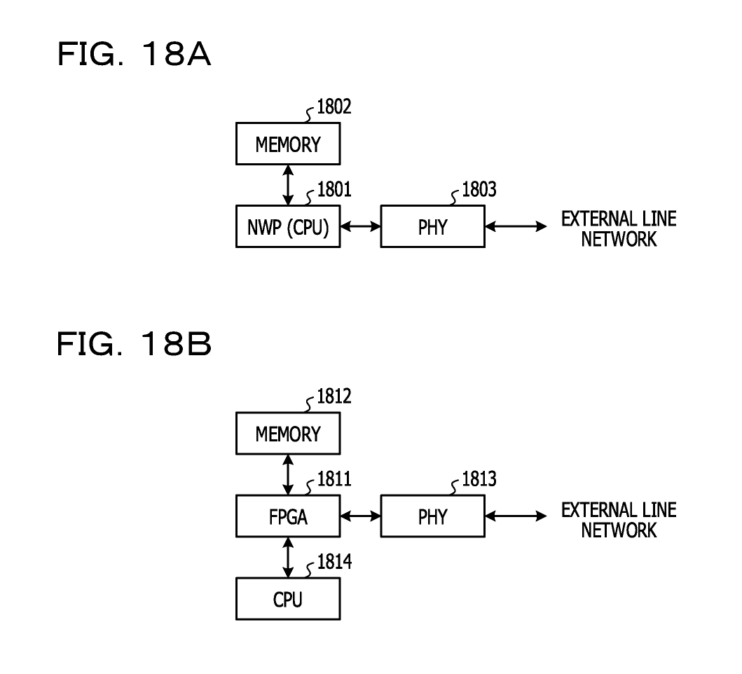

FIG. 18A and FIG. 18B are diagrams illustrating an example of hardware configuration in which embodiments of the transmitting side device 200 of FIG. 2 and the receiving side device 300 of FIG. 3 may be implemented as a terminating device (for example, the Node A (termination) 103 or the Node E (termination) 103 in FIG. 1).

FIG. 18A represents an example of hardware configuration in which the transmitting side device 200 and the receiving side device 300 are implemented by a processor configuration. A network processor (NWP) 1801 as a central processing unit (CPU) implements the respective functions of the L3 processing unit 201 and the L2 processing unit 202 in the transmitting side device 200 of FIG. 2 and the L2 processing unit 302 and the L3 processing unit 303 in the receiving side device 300 of FIG. 3 by executing a control program stored in a memory 1802. A physical layer processing circuit (PHY) 1803 is a circuit that processes an electric or optical interface with an external line network. The physical layer processing circuit 1803 implements the functions of the L1 processing unit 203 in the transmitting side device 200 of FIG. 2 and the L1 processing unit 301 in the receiving side device 300 of FIG. 3.

FIG. 18B represents an example of hardware configuration in which the transmitting side device 200 and the receiving side device 300 are implemented by a field programmable gate array (FPGA). The FPGA 1811 forms a logic circuit that implements the respective functions of the L3 processing unit 201 and the L2 processing unit 202 in the transmitting side device 200 of FIG. 2 and the L2 processing unit 302 and the L3 processing unit 303 in the receiving side device 300 of FIG. 3 while using a memory 1812 under control of a CPU 1814. The physical layer processing circuit (PHY) 1813 is similar to the physical layer processing circuit 1803 in FIG. 18A, and is a circuit that processes an electric or optical interface with an external line network. The physical layer processing circuit 1813 implements the functions of the L1 processing unit 203 in the transmitting side device 200 of FIG. 2 and the L1 processing unit 301 in the receiving side device 300 of FIG. 3.

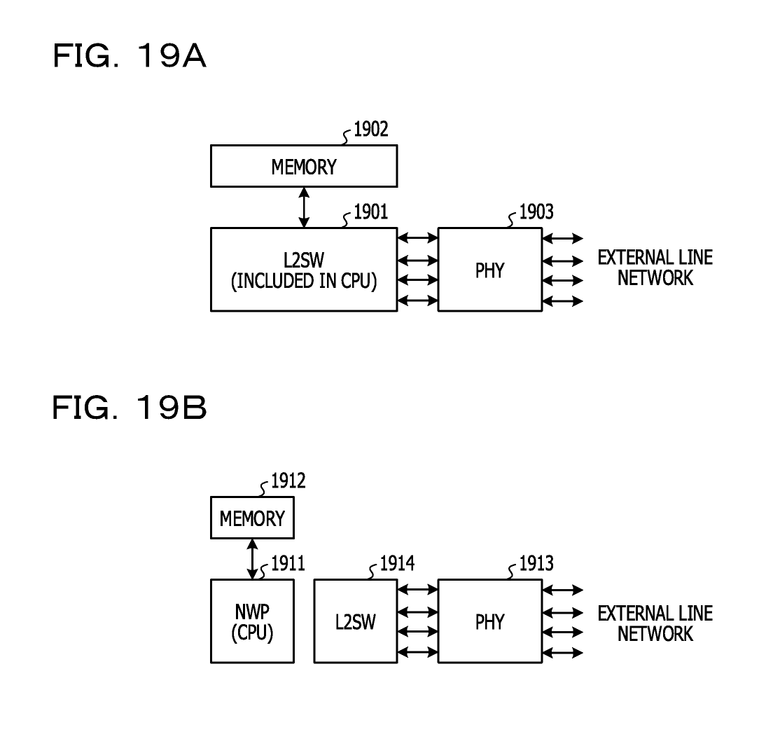

FIG. 19A and FIG. 19B are diagrams illustrating an example of hardware configuration in which embodiments of the transmitting side device 200 of FIG. 2 and the receiving side device 300 of FIG. 3 may be implemented as a relay device (for example, the Node B (L2SW) 101 or the Node C/D (Router) 102 in FIG. 1).

FIG. 19A represents an example of hardware configuration in which the functions of the relay device are implemented by a processor configuration. An NWP 1901 as a CPU executes a control program stored in a memory 1902. The NWP 1901 thereby implements, for example, the functions of an L2 switch (L2SW) performing relaying in the L2 layer, the L2 processing unit 302 in FIG. 3, the L2 processing unit 302 being disposed in an input port part of the L2 switch, and the L2 processing unit 202 in FIG. 2, the L2 processing unit 202 being disposed in an output port part of the L2 switch. A physical layer processing circuit (PHY) 1903 is a circuit that processes an electric or optical interface with an external line network. The physical layer processing circuit 1903 implements the functions of the L1 processing unit 203 in the transmitting side device 200 of FIG. 2 and the L1 processing unit 301 in the receiving side device 300 of FIG. 3.

FIG. 19B includes an L2 switch (L2SW) 1914 implemented by hardware and a physical layer processing circuit (PHY) 1913 that processes an electric or optical interface with an external line network. Then, an FPGA 1911 and a memory 1912 implement the functions of the L2 processing unit 302 in FIG. 3, the L2 processing unit 302 being disposed in an input port part of the L2 switch, and the L2 processing unit 202 in FIG. 2, the L2 processing unit 202 being disposed in an output port part of the L2 switch.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method executed by a processor included in a communication device, the communication method comprising:
starting transmitting a first frame;
when an opportunity to transmit a second frame having a higher priority than the first frame occurs during transmission of the first frame, generating a third frame including a part of data of the first frame;
transmitting the generated third frame;
transmitting the second frame after transmitting the generated third frame;
generating a fourth frame including a header of the first frame and untransmitted data of the first frame after transmitting the second frame; and
transmitting the generated fourth frame.

2. The communication method according to claim 1, wherein
the processor executes frame transmission processing in a layer 2,
the transmitting the third frame or the fourth frame includes storing, in the header of the first frame, a virtual local area network tag field storing a given tag protocol identifier indicating that the first frame may be divided, and transmitting the virtual local area network tag field,
the generating the third frame includes adding a first fragment field storing assembly information for assembling the first frame to a tail end of a payload of the third frame, and
the generating the fourth frame includes adding a second fragment field storing the assembly information to a tail end of a payload of the fourth frame.

3. The communication method according to claim 2, further comprising
storing a priority of the third frame or the fourth frame in the virtual local area network tag field of the third frame or the fourth frame.

4. The communication method according to claim 2, wherein the assembly information includes:
identifier information indicating that the third or fourth frame including the assembly information is divided from the given first frame,
flag information indicating whether or not another fourth frame divided from the first frame corresponding to the third or fourth frame follows the third or fourth frame including the assembly information,
offset information indicating an offset of the divided data stored in the third or fourth frame including the assembly information in the data of the first frame corresponding to the third or fourth frame, and
information indicating a size of the data of the first frame corresponding to the third or fourth frame including the assembly information.

5. The communication method according to claim 2, wherein the assembly information includes:
identifier information indicating that the third or fourth frame including the assembly information is divided from the same first frame,
information indicating the number of divisions in the first frame corresponding to the third or fourth frame including the assembly information, and
information indicating a division order of the divided data stored in the third or fourth frame including the assembly information in the data of the first frame corresponding to the third or fourth frame.

6. A device comprising:
a memory; and
a processor coupled to the memory and configured to
start transmitting a first frame;
generate a third frame including a part of data of a first frame when an opportunity to transmit a second frame having a higher priority than the first frame occurs during transmission of the first frame,
transmit the generated third frame,
transmit the second frame after transmitting the generated third frame,
generate a fourth frame including a header of the first frame and untransmitted data of the first frame after transmitting the second frame, and
transmit the generated fourth frame.

7. A system comprising:
a first communication device configured to:
start transmitting a first frame,
when an opportunity to transmit a second frame having a higher priority than the first frame occurs during transmission of the first frame, generate a third frame including a part of data of the first frame,
transmit the generated third frame,
transmit the second frame after transmitting the generated third frame,
generate a fourth frame including a header of the first frame and untransmitted data of the first frame after transmitting the second frame, and
transmit the generated fourth frame; and
a second communication device configured to:
receive frames including the second frame, the third frame, and the fourth frame,
separate the received frames into the third or fourth frame and the second frame on a basis of a result of determination of whether or not a virtual local area network tag field storing a given tag protocol identifier is added and whether or not a fragment field indicating that the received frame is divided is added to a tail end of a payload in the received frame, and
assemble the first frame from the third frame or the fourth frame on a basis of assembly information within the fragment field added to the third frame or the fourth frame.

8. The system according to claim 7, wherein the second communication device is configured to:
perform transmission, reception, or relay processing of a frame including the virtual local area network tag field as a frame not belonging to any virtual local area network when zero is set as a virtual local area network identifier in the virtual local area network tag field, by registering and referring to a given tag protocol identifier in the virtual local area network tag field as a virtual local area network tag, and
perform transmission, reception, or relay processing of the frame including the virtual local area network tag field as a frame belonging to a given virtual local area network when a given value between 1 to 4094 both inclusive is set as the virtual local area network identifier.

9. The system according to claim 8, wherein the first communication device is configured to
determine whether or not to perform division processing from the first frame to the third or fourth frame on a basis of information set for each given tag protocol identifier.

10. The system according to claim 8, wherein the second communication device is configured to
determine whether or not to perform assembly processing from the third or fourth frame to the first frame on a basis of information set for each given tag protocol identifier.

11. The system according to claim 8, wherein the second communication device is configured to
communicate the frame subjected to the reception or relay processing when the given tag protocol identifier is not stored in the virtual local area network tag field in the frame subjected to the reception or relay processing.
